(19) United States
(12) Patent Application Publication
(10) Pub. No.: US 2025/0185026 A1
(43) Pub. Date: Jun. 5, 2025

(54) EHNHANCEMENT OF RESOURCE SELECTION FOR SIDELINK DISCONTINUOUS RECEPTION (DRX) RECEIVER USER EQUIPMENT (UE)

(71) Applicant: Apple Inc., Cupertino, CA (US)

(72) Inventors: Chunhai Yao, Beijing (CN); Chunxuan Ye, San Diego, CA (US); Dawei Zhang, Saratoga, CA (US); Haijing Hu, Los Gatos, CA (US); Haitong Sun, Saratoga, CA (US); Hong He, San Jose, CA (US); Wei Zeng, Saratoga, CA (US); Weidong Yang, San Diego, CA (US); Yushu Zhang, Beijing (CN); Zhibin Wu, Los Altos, CA (US)

(21) Appl. No.: 18/719,418

(22) PCT Filed: Jan. 10, 2022
(86) PCT No.: PCT/CN2022/071145

§ 371 Date: Jun. 13, 2024

(51) Int. Cl. H04W 72/25; H04W 76/28

(52) U.S. Cl. CPC H04W 72/25; H04W 76/28

(57) ABSTRACT

A user equipment (UE), including a vehicle to everything (V2X) device, a pedestrian UE, or other UE, a baseband processor or other network device can operate to receive an indication of a sidelink (SL) discontinuous reception (DRX) parameter (e.g., an SL DRX active time) of a receiver UE for SL communication (e.g., Mode-2 SL communication). A resource selection procedure can be performed of a set of candidate resources within a resource selection window (RSW) based on the SL DRX parameter of the receiver UE so that at least a subset of candidate resources of the set of candidate resources satisfies a threshold to be within the SL DRX parameter of the receiver UE. A report of the set of candidate resources can then be transmitted from the physical (PHY) layer to a higher layer to enable the SL communication. The SL communication, for example, can include an autonomous determination of SL resources for a Mode-2 sidelink communication.

### FIELD

The present disclosure relates to wireless technology including resource selection for sidelink discontinuous reception (DRX) in a receiver user equipment (UE).

### BACKGROUND

Mobile communication in the next generation wireless communication system, 5G, or new radio (NR) network will provide ubiquitous connectivity and access to information, as well as ability to share data, around the globe. 5G networks and network slicing will be a unified, service-based framework that will target to meet versatile and sometimes, conflicting performance criteria to provide services to vastly heterogeneous application domains ranging from Enhanced Mobile Broadband (eMBB) to massive Machine-Type Communications (mMTC), Ultra-Reliable Low-Latency Communications (URLLC), and other communications. In general, NR will evolve based on third generation partnership project (3GPP) long term evolution (LTE)-Advanced technology with additional enhanced radio access technologies (RATs) to enable seamless and faster wireless connectivity solutions. Another type of mobile communication includes vehicle communication, where vehicles communicate or exchange vehicle related information. The vehicle communication can include vehicle to everything (V2X), which includes vehicle to vehicle (V2V), vehicle to infrastructure (V2I) and vehicle to pedestrian (V2P) where direct communication without a base station may be employed, such as in a sidelink (SL) communication.

In some situations, vehicle related information is intended for a single vehicle or other entity. In other situations, such as emergency alerts, vehicle related information is intended for a large number of vehicles and/or other entities. The emergency alerts can include collision warnings, control loss warnings, and the like.

V2P communication and associated applications provide an ever-increasing potential benefit for safety between vehicles and pedestrian devices, which can include one or more of: bicyclist, children being pushed in baby carriages/strollers, walkers, joggers, people embarking on trains and busses, drivers, passengers, or more with a mobile device. V2P communications can ensure that a vehicle with adequate safety components and applications and the pedestrian user equipment (P-UE) are aware of one another sufficiently to avoid a collision, for example.

### BRIEF DESCRIPTION OF THE DRAWINGS

FIG. 1 illustrates an exemplary block diagram illustrating an example of user equipment(s) (UEs) communicatively coupled a network with network components as peer devices useable in connection with various embodiments (aspects) described herein.

FIG. 2 illustrates a diagram illustrating example components of a device that can be employed in accordance with various aspects discussed herein.

FIG. 3 illustrates an example simplified block diagram of a user equipment (UE) wireless communication device or other network device/component (e.g., eNB, gNB) in accordance with various aspects.

FIG. 4 illustrates an illustrates an example sensing and selection window timeline in accordance with various aspects.

FIG. 5 illustrates another example sensing and selection window timeline in accordance with various aspects.

FIG. 6 illustrates an example process flow of resource selection according to various aspects.

FIG. 7 illustrates another example process flow of resource selection according to various aspects.

FIG. 8 illustrates another example process flow of resource selection according to various aspects.

FIG. 9 illustrates an example system in SL communication to various aspects.

FIG. 10 illustrates an example timeline of operations of partial sensing for aperiodic transmission according to various aspects.

FIG. 11 illustrates another example of process flow for congestion control in sidelink communications according to various aspects.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Various aspects including a user equipment (UE) device operating in sidelink (SL) communication and selecting resources to enable SL communication are described herein. The UE device can be a pedestrian UE (P-UE) device, a vehicle-to-everything (V2X) device, or other UE that may include vehicle-to-vehicle (V2V), vehicle-to-infrastructure (V2I), vehicle-to-pedestrian (V2P) device communication, or other direct communication between UEs, which can comprise a sidelink (SL) communication; each transmitter and receiver can include a user equipment (UE) device. A UE when referred to herein can also further include a Roadside Unit (RSU), a drone, other vehicle device, Internet of Things (IoT) device, or other user equipment device, for example.

Power saving, as well as latency, are important considerations when utilizing SL communication, which can be a direct communication between UE terminals (e.g., a transmitter UE and a receiver UE in a unicast transmission). Specifically, because safety-related traffic requires low latency, uplink and downlink communications that pass through a base station may not necessarily meet latency requirements in certain situations (e.g., emergency messaging or other urgencies). Thus, sidelink communication can be configured for direct communication between UEs as autonomous vehicles, pedestrian UEs or the like.

A P-UE or other UE device may have different power saving restraints compared to vehicle devices (e.g., V2X device or V-UE) when engaging in SL communication. As such, various enhancements are discussed herein to enable powering saving operation, which may apply to any UE, but may be well suited for power limited UEs such as a P-UE compared to a vehicle UE (V-UE). Two main power saving operations for enhancing SL communication by saving power can include sidelink discontinuous reception (SL DRX) and partial/reduced sensing. Various aspects as described herein configure these power saving enhancements in SL communication in accordance with recent 3GPP standard agreements associated with resource selection and partial sensing with SL DRX.

When a UE operates in SL DRX mode, it may cycle between active and inactive times, communicating during active times while refraining from communicating during inactive times. In one example, mechanisms are defined to ensure that at least a subset of candidate resources are located within an indicated active time of the receiver UE. This can enable resources to be selected from among candidate resources by the transmitting UE that ensures the resources being within the receiver UE's active time, rather than being within the receiver UE's inactive time when it may not be monitoring the sidelink channel. In some instances, this increases or maximizes the number of selected resources that are located within the receiving UE's active time and improves the receiving UE's reception of transmissions from the transmitting UE.

Two different types of categories of sidelink communication are known based on the resource allocation method configured: mode-1 communication and mode-2 communication. Mode-1 communication includes a method where a base station (e.g., gNB or eNB) allocates usable resources for direct communication between terminals (different UEs) and can be used when all terminals that perform sidelink communication are in an in-coverage situation. Mode-2 communication is a method where each UE or terminal selects usable resources for direct communication and can be used even when the terminals are in an out-of-coverage situation. Because the base station does not intervene in resource allocation for mode-2 communication, the UE identifies the usable resources itself. Sensing is used for identifying resources that can be used for the sidelink, in order to decode the physical sidelink control channel (PSCCH) during a sensing window of a certain period before performing the sidelink transmission. However, sensing can consume a large amount of power where the PSCCH needs to be continuously decoded, even when not transmitting.

Partial sensing or reduced sensing can be used to reduce the power consumption of a UE operating in a signal environment of a mode-2 sidelink communication. In the case of vehicular user equipment (V-UE), power consumption is not a major concern because the power is provided by the vehicle; however, in the case of a pedestrian user equipment (P-UE) or similar UE device, the reduction in power consumption provides significant benefits because the battery life of each P-UE is more critical. To address these power consumption issues for sensing, partial sensing can be utilized for sidelink communication among UEs. Partial sensing, or reduced sensing, is referred to herein as a method of checking available resources by decoding PSCCH for only a part of an entire data period. When partial sensing is used, the power consumption can be reduced to the extent that the decoding time is reduced.

In addition, power consumption can also be reduced by configuring SL DRX. SL DRX can refer to the UE monitoring the sidelink channel for sidelink data reception during a DRX active time in a normal connected operation, and not necessarily monitoring the sidelink channel or receiving sidelink data during the DRX inactive time as in an idle mode.

Potential issues can arise where a transmitting UE and a receiving/receiver UE participate in a sidelink unicast communication. The DRX active time of the receiver UE can be indicated to the transmitter UE (e.g., via a higher layer) to ensure the transmitting UE is effectively selecting resources for mode-2 SL communications. Various aspects herein serve to provide advantages that enhance power saving for mode-2 SL communication by configuring selection and reporting of candidate resources so that at least a subset of the candidate resources of the set of candidate resources is within with the SL DRX active time of the receiver UE. Various aspects for the transmitting UE to consider the SL DRX parameters of the receiver UE include ensuring that at least a subset of candidate resources is within an SL DRX active time of the receiver UE, modifying the resource selection window to overlap with the SL DRX active time, and effectively processing when the number of candidate resources of the subset of candidate resources is lower than a threshold for selected resources to be within the SL DRX active time.

In other aspects, to enable partial sensing of candidate resources for further power saving operation in SL communication, re-evaluation/pre-emption checking for aperiodic transmission can be configured also when the UE has aperiodic traffic. The UE performs a selected resource re-evaluation and pre-emption checking for periodic transmission in SL communications, and then does a power saving reduced sensing for the re-evaluation and pre-emption checking according to 3GPP agreement. This re-evaluation refers to the UE performing a check of candidate resources it has previously selected as to whether these resources are still available and good for use, while pre-emption refers to being before transmission of the selected resource(s). The UE can be configured with various aspects to enable the power saving of partial sensing by initializing a set of candidate resources to remaining candidate slots, where the slot indices are used from the initial resource (re) selection procedure.

In yet other aspects, the UE can be configured or not to measure a sidelink channel busy ratio (SL CBR) during the SL DRX inactive time, depending on certain conditions. SL CBR can also be used to reduce power for UEs as a further advantage involved in SL communication with SL DRX by halting the SL communication when the measured SL CBR satisfies a preconfigured threshold, indicating the channel is unusually busy, for example.

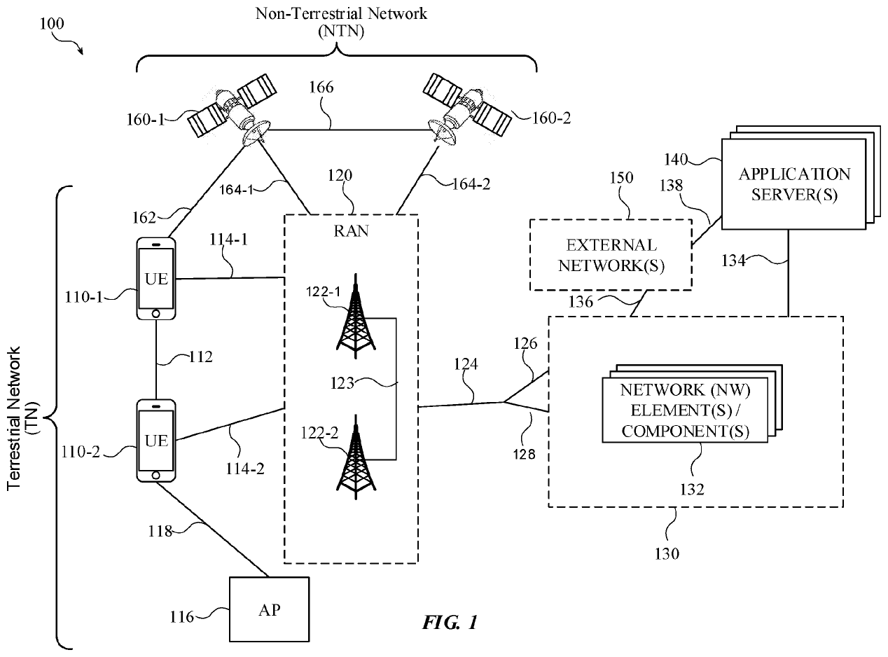

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, external networks 150, and satellites 160-1, 160-2, etc. (referred to collectively as “satellites 160” and individually as “satellite 160”). As shown, network 100 may include a non-terrestrial network (NTN) comprising one or more satellites 160 (e.g., of a global navigation satellite system (GNSS)) in communication with UEs 110 and RAN 120.

The systems and devices of example network 100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with (e.g., be communicatively coupled) with RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 130. Additionally, at least one of the MN or the SN may be operated with shared spectrum channel access, and functions specified for UE 110 can be used for an integrated access and backhaul mobile termination (IAB-MT). Similar for UE 110, the IAB-MT may access the network using either one network node or using two different nodes with enhanced dual connectivity (EN-DC) architectures, new radio dual connectivity (NR-DC) architectures, or other direct connectivity such as a sidelink communication channel as an SL interface 112. In some implementations, a base station (as described herein) may be an example of network node 122.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 1207 may comprise a local wireless connection, such as a connection consistent with any IEEE 702.11 protocol, and AP 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or other like having smaller coverage areas, smaller user capacity, or higher bandwidth compared to macrocells. As described below, in some implementations, satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and also to implementation where the base station, RAN node 122, etc., is a non-terrestrial network node (e.g., satellite 160).

Some or all of RAN nodes 122 may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gNB-distributed units (DUs) connected to a gNB-control unit (CU) via individual F1 interfaces. In such implementations, the gNB-DUs may include one or more remote radio heads or radio frequency (RF) front end modules (RFEMs), and the gNB-CU may be operated by a server (not shown) located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may include channels that operate in the frequency range of approximately 400 MHz to approximately 3.8 GHZ, whereas the unlicensed spectrum may include the 5 GHz band or higher, for example. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 110 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein a number of CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 122 may be configured to communicate with one another via interface 123. In implementations where the system is an LTE system, interface 123 may be an X2 interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CM 130 (e.g., universal mobile telecommunications system packet services (UMTS PS) domain, LTE PS data services, etc.). Application servers 140 may also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

As shown, example network 100 may include an NTN that may comprise one or more satellites 160-1 and 160-2 (collectively, “satellites 160”). Satellites 160 may be in communication with UEs 110 via service link or wireless interface 162 and/or RAN 120 via feeder links or wireless interfaces 164 (depicted individually as 164-1 and 164). In some implementations, satellite 160 may operate as a passive or transparent network relay node regarding communications between UE 110 and the terrestrial network (e.g., RAN 120). In some implementations, satellite 160 may operate as an active or regenerative network node such that satellite 160 may operate as a base station to UEs 110 (e.g., as a gNB of RAN 120) regarding communications between UE 110 and RAN 120. In some implementations, satellites 160 may communicate with one another via a direct wireless interface (e.g., 166) or an indirect wireless interface (e.g., via RAN 120 using interfaces 164-1 and 164-2).

Additionally, or alternatively, satellite 160 may include a GEO satellite, LEO satellite, or another type of satellite. Satellite 160 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and implementation, where the base station, RAN node 122, etc., is a non-terrestrial network node (e.g., satellite 160).

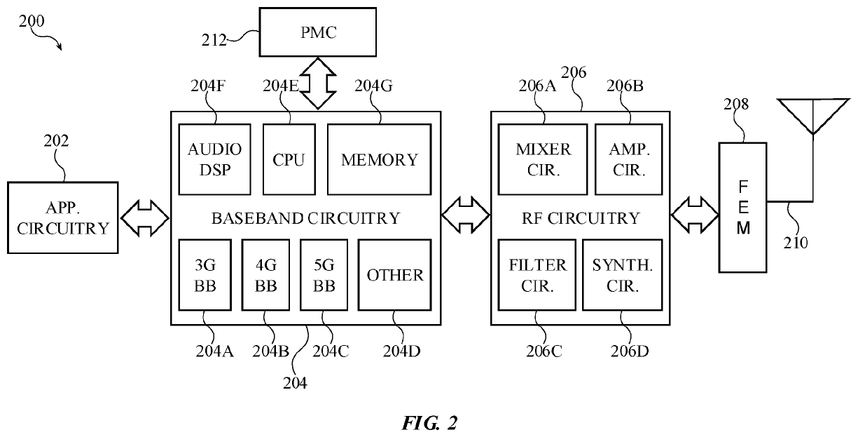

FIG. 2 illustrates example components of a device 200 in accordance with some aspects. In some aspects, the device 200 can include application circuitry 202, baseband circuitry 204, Radio Frequency (RF) circuitry 206, front-end module (FEM) circuitry 208, one or more antennas 210, and power management circuitry (PMC) 212 coupled together at least as shown. The components of the illustrated device 200 can be included in a UE or a RAN node. In some aspects, the device 200 can include fewer elements (e.g., a RAN node cannot utilize application circuitry 202, and instead include a processor/controller to process IP data received from a CN such as 5GC 120 or an Evolved Packet Core (EPC)). In some aspects, the device 200 can include additional elements such as, for example, memory/storage, display, camera, sensor (including one or more temperature sensors, such as a single temperature sensor, a plurality of temperature sensors at different locations in device 200, etc.), or input/output (I/O) interface. In other aspects, the components described below can be included in more than one device (e.g., said circuitries can be separately included in more than one device for Cloud-RAN (C-RAN) implementations).

The application circuitry 202 can include one or more application processors. For example, the application circuitry 202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 200. In some aspects, processors of application circuitry 202 can process IP data packets received from an EPC.

The baseband circuitry 204 can include circuitry such as, but not limited to, one or more single-core or multi-core processors. The baseband circuitry 204 can include one or more baseband processors or control logic to process baseband signals received from a receive signal path of the RF circuitry 206 and to generate baseband signals for a transmit signal path of the RF circuitry 206. Baseband circuitry 204 can interface with the application circuitry 202 for generation and processing of the baseband signals and for controlling operations of the RF circuitry 206. For example, in some aspects, the baseband circuitry 204 can include a third generation (3G) baseband processor 204A, a fourth generation (4G) baseband processor 204B, a fifth generation (5G) baseband processor 204C, or other baseband processor(s) 204D for other existing generations, generations in development or to be developed in the future (e.g., second generation (2G), sixth generation (6G), etc.). The baseband circuitry 204 (e.g., one or more of baseband processors 204A-D) can handle various radio control functions that enable communication with one or more radio networks via the RF circuitry 206. In other aspects, some, or all of the functionality of baseband processors 204A-D can be included in modules stored in the memory 204G and executed via a Central Processing Unit 204E. Memory 204G can include executable components or instructions to cause one or more processors (e.g., baseband circuitry 204) to perform aspects, processes or operations herein. The radio control functions can include, but are not limited to, signal modulation/demodulation, encoding/decoding, radio frequency shifting, etc. In some aspects, modulation/demodulation circuitry of the baseband circuitry 204 can include Fast-Fourier Transform (FFT), precoding, or constellation mapping/demapping functionality. In some aspects, encoding/decoding circuitry of the baseband circuitry 204 can include convolution, tail-biting convolution, turbo, Viterbi, or Low Density Parity Check (LDPC) encoder/decoder functionality. Aspects of modulation/demodulation and encoder/decoder functionality are not limited to these examples and can include other suitable functionality in other aspects.

In some aspects, the baseband circuitry 204 can include one or more audio digital signal processor(s) (DSP) 204F. The audio DSP(s) 204F can include elements for compression/decompression and echo cancellation and can include other suitable processing elements in other aspects. Components of the baseband circuitry can be suitably combined in a single chip, a single chipset, or disposed on a same circuit board in some aspects. In some aspects, some, or all of the constituent components of the baseband circuitry 204 and the application circuitry 202 can be implemented together such as, for example, on a system on a chip (SOC).

In some aspects, the baseband circuitry 204 can provide for communication compatible with one or more radio technologies. For example, in some aspects, the baseband circuitry 204 can support communication with a NG-RAN, an evolved universal terrestrial radio access network (EUTRAN) or other wireless metropolitan area networks (WMAN), a wireless local area network (WLAN), a wireless personal area network (WPAN), etc. Aspects in which the baseband circuitry 204 is configured to support radio communications of more than one wireless protocol can be referred to as multi-mode baseband circuitry.

RF circuitry 206 can enable communication with wireless networks using modulated electromagnetic radiation through a non-solid medium. In various aspects, the RF circuitry 206 can include switches, filters, amplifiers, etc. to facilitate the communication with the wireless network. RF circuitry 206 can include a receive signal path which can include circuitry to down-convert RF signals received from the FEM circuitry 208 and provide baseband signals to the baseband circuitry 204. RF circuitry 206 can also include a transmit signal path which can include circuitry to up-convert baseband signals provided by the baseband circuitry 204 and provide RF output signals to the FEM circuitry 208 for transmission.

In some aspects, the receive signal path of the RF circuitry 206 can include mixer circuitry 206a, amplifier circuitry 206b and filter circuitry 206c. In some aspects, the transmit signal path of the RF circuitry 206 can include filter circuitry 206c and mixer circuitry 206a. RF circuitry 206 can also include synthesizer circuitry 206d for synthesizing a frequency for use by the mixer circuitry 206a of the receive signal path and the transmit signal path. In some aspects, the mixer circuitry 206a of the receive signal path can be configured to down-convert RF signals received from the FEM circuitry 208 based on the synthesized frequency provided by synthesizer circuitry 206d. The amplifier circuitry 206b can be configured to amplify the down-converted signals and the filter circuitry 206c can be a low-pass filter (LPF) or band-pass filter (BPF) configured to remove unwanted signals from the down-converted signals to generate output baseband signals. Output baseband signals can be provided to the baseband circuitry 204 for further processing. In some aspects, the output baseband signals can be zero-frequency baseband signals, although this is not a requirement. In some aspects, mixer circuitry 206a of the receive signal path can comprise passive mixers, although the scope of the aspects is not limited in this respect.

In some aspects, the mixer circuitry 206a of the transmit signal path can be configured to up-convert input baseband signals based on the synthesized frequency provided by the synthesizer circuitry 206d to generate RF output signals for the FEM circuitry 208. The baseband signals can be provided by the baseband circuitry 204 and can be filtered by filter circuitry 206c.

In some aspects, the mixer circuitry 206a of the receive signal path and the mixer circuitry 206a of the transmit signal path can include two or more mixers and can be arranged for quadrature downconversion and upconversion, respectively. In some aspects, the mixer circuitry 206a of the receive signal path and the mixer circuitry 206a of the transmit signal path can include two or more mixers and can be arranged for image rejection (e.g., Hartley image rejection). In some aspects, the mixer circuitry 206a of the receive signal path and the mixer circuitry 206a can be arranged for direct downconversion and direct upconversion, respectively. In some aspects, the mixer circuitry 206a of the receive signal path and the mixer circuitry 206a of the transmit signal path can be configured for super-heterodyne operation.

In some aspects, the output baseband signals and the input baseband signals can be analog baseband signals, although the scope of the aspects is not limited in this respect. In some alternate aspects, the output baseband signals and the input baseband signals can be digital baseband signals. In these alternate aspects, the RF circuitry 206 can include analog-to-digital converter (ADC) and digital-to-analog converter (DAC) circuitry and the baseband circuitry 204 can include a digital baseband interface to communicate with the RF circuitry 206.

In some dual-mode aspects, a separate radio IC circuitry can be provided for processing signals for each spectrum, although the scope of the aspects is not limited in this respect.

In some aspects, the synthesizer circuitry 206d can be a fractional-N synthesizer or a fractional N/N+1 synthesizer, although the scope of the aspects is not limited in this respect as other types of frequency synthesizers can be suitable. For example, synthesizer circuitry 206d can be a delta-sigma synthesizer, a frequency multiplier, or a synthesizer comprising a phase-locked loop with a frequency divider.

The synthesizer circuitry 206d can be configured to synthesize an output frequency for use by the mixer circuitry 206a of the RF circuitry 206 based on a frequency input and a divider control input. In some aspects, the synthesizer circuitry 206d can be a fractional N/N+1 synthesizer.

In some aspects, frequency input can be provided by a voltage controlled oscillator (VCO), although that is not a requirement. Divider control input can be provided by either the baseband circuitry 204 or the application circuitry 202 depending on the desired output frequency. In some aspects, a divider control input (e.g., N) can be determined from a look-up table based on a channel indicated by the application circuitry 202.

Synthesizer circuitry 206d of the RF circuitry 206 can include a divider, a delay-locked loop (DLL), a multiplexer and a phase accumulator. In some aspects, the divider can be a dual modulus divider (DMD) and the phase accumulator can be a digital phase accumulator (DPA). In some aspects, the DMD can be configured to divide the input signal by either N or N+1 (e.g., based on a carry out) to provide a fractional division ratio. In some example aspects, the DLL can include a set of cascaded, tunable, delay elements, a phase detector, a charge pump and a D-type flip-flop. In these aspects, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some aspects, synthesizer circuitry 206d can be configured to generate a carrier frequency as the output frequency, while in other aspects, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some aspects, the output frequency can be a LO frequency (fLO). In some aspects, the RF circuitry 206 can include an IQ/polar converter.

FEM circuitry 208 can include a receive signal path which can include circuitry configured to operate on RF signals received from one or more antennas 210, amplify the received signals and provide the amplified versions of the received signals to the RF circuitry 206 for further processing. FEM circuitry 208 can also include a transmit signal path which can include circuitry configured to amplify signals for transmission provided by the RF circuitry 206 for transmission by one or more of the one or more antennas 210. In various aspects, the amplification through the transmit or receive signal paths can be done solely in the RF circuitry 206, solely in the FEM circuitry 208, or in both the RF circuitry 206 and the FEM circuitry 208.

In some aspects, the FEM circuitry 208 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 206). The transmit signal path of the FEM circuitry 208 can include a power amplifier (PA) to amplify input RF signals (e.g., provided by RF circuitry 206), and one or more filters to generate RF signals for subsequent transmission (e.g., by one or more of the one or more antennas 210).

In some aspects, the PMC 212 can manage power provided to the baseband circuitry 204. In particular, the PMC 212 can control power-source selection, voltage scaling, battery charging, or DC-to-DC conversion. The PMC 212 can often be included when the device 200 is capable of being powered by a battery, for example, when the device is included in a UE. The PMC 212 can increase the power conversion efficiency while providing desirable implementation size and heat dissipation characteristics.

While FIG. 2 shows the PMC 212 coupled only with the baseband circuitry 204. However, in other aspects, the PMC 212 can be additionally or alternatively coupled with, and perform similar power management operations for, other components such as, but not limited to, application circuitry 202, RF circuitry 206, or FEM circuitry 208.

In some aspects, the PMC 212 can control, or otherwise be part of, various power saving mechanisms of the device 200. For example, if the device 200 is in an RRC_Connected state, where it is still connected to the RAN node as it expects to receive traffic shortly, then it can enter a state known as Discontinuous Reception Mode (DRX) after a period of inactivity. During this state, the device 200 can power down for brief intervals of time and thus save power.

If there is no data traffic activity for an extended period of time, then the device 200 can transition off to an RRC_Idle state, where it disconnects from the network and does not perform operations such as channel quality feedback, handover, etc. The device 200 goes into a very low power state and it performs paging where again it periodically wakes up to listen to the network and then powers down again. The device 200 cannot receive data in this state; in order to receive data, it can transition back to RRC_Connected state.

An additional power saving mode can allow a device to be unavailable to the network for periods longer than a paging interval (ranging from seconds to a few hours). During this time, the device is totally unreachable to the network and can power down completely. Any data sent during this time incurs a large delay and it is assumed the delay is acceptable.

Processors of the application circuitry 202 and processors of the baseband circuitry 204 can be used to execute elements of one or more instances of a protocol stack. For example, processors of the baseband circuitry 204, alone or in combination, can be used to execute Layer 3 (L3), Layer 2 (L2), or Layer 1 (L1) functionality, while processors of the application circuitry 202 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control (RRC) layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node.

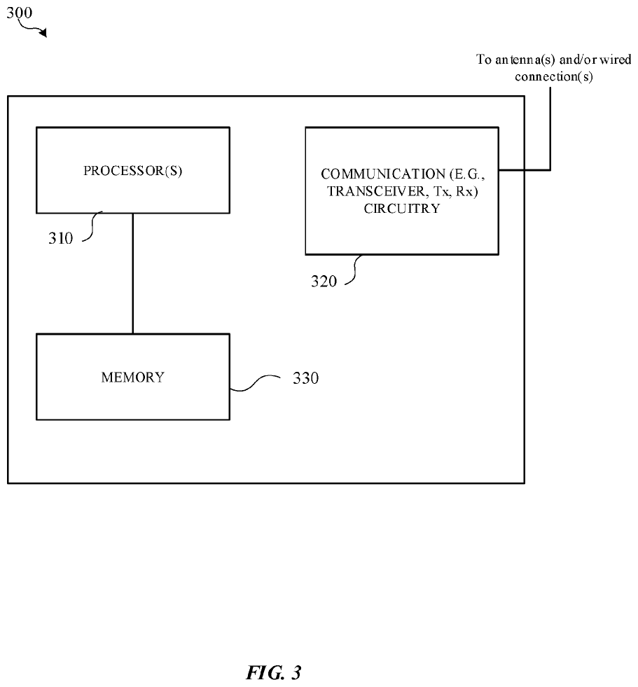

Referring to FIG. 3, illustrated is a block diagram of a user equipment (UE) device or another network device/component (e.g., V-UE/P-UE, IoT, gNB, eNB, or other participating network entity/component). The device 300 includes one or more processors 310 (e.g., one or more baseband processors) comprising processing circuitry and associated interface(s), transceiver circuitry 320 (e.g., comprising RF circuitry, which can comprise transmitter circuitry (e.g., associated with one or more transmit chains) and/or receiver circuitry (e.g., associated with one or more receive chains) that can employ common circuit elements, distinct circuit elements, or a combination thereof), and a memory 330 (which can comprise any of a variety of storage mediums and can store instructions and/or data associated with one or more of processor(s) 310 or transceiver circuitry 320).

Memory 330 (as well as other memory components discussed herein, e.g., memory, data storage, or the like) can comprise one or more machine-readable medium/media including instructions that, when performed by a machine or component herein cause the machine or other device to perform acts of a method, an apparatus or system for communication using multiple communication technologies according to aspects, embodiments and examples described herein. It is to be understood that aspects described herein can be implemented by hardware, software, firmware, or any combination thereof. When implemented in software, functions can be stored on or transmitted over as one or more instructions or code on a computer-readable medium (e.g., the memory described herein or other storage device). Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Also, any connection can also be termed a computer-readable medium.

In an aspect, the UE/gNB device 300 can operate to configure by processing/generating/encoding/decoding a physical (PHY) layer transmission to/from a higher layer (e.g., MAC layer), comprising multiple different transport blocks (TBs) based on an unequal protection between the different TBs in a physical layer encapsulation (e.g., EPC packets, a transmission opportunity, MCOT, a single transmission burst, a TTI or other encapsulation protocol or related encapsulation parameter(s) for the encapsulation of data from higher layers into frames for transmission over the air. The physical (PHY) layer transmission can be received, transmitted, or provide (d) with communication/transmitter circuitry 320 to similarly process/generate the physical layer transmission with spatial layers via a physical channel in an NR network or other networks.

Processor(s) 310 can be components of application/processing circuitry or processor(s) of the baseband circuitry that can be used to execute components or elements of one or more instances of a protocol stack. For example, processor(s) 310 of baseband circuitry, alone or in combination, as processing circuitry, can be configured, in an aspect, to receive an indication of a SL discontinuous reception (DRX) parameter of a receiver UE for mode-2 SL communication. Because mode-2 SL communication is SL communication where a base station does not intervene in resource allocation, the processing circuitry can further perform a resource selection procedure of a set of candidate resources (or a candidate resource set (S_{A})) based on the SL DRX parameter of the receiver UE, and further so that at least a subset of candidate resources of the set of candidate resources satisfies a threshold of the SL DRX parameter of the receiver UE. For example, a threshold amount (by percentage, ratio, or number) of the candidate resource set (S_{A}), or the subset of candidate resources can overlap with the SL DRX active time as the SL DRX parameter. After ensuring the threshold is satisfied a report of the set of candidate resources can be transmitted from the PHY layer to a higher layer (e.g., a MAC layer) to enable SL communication. Additionally, partial sensing with a partial sensing window can be configured as a part of the resource selection procedure so that a resource selection window (RSW) overlaps with the indicated SL DRX active time of the receiver UE accordingly. Various aspects can also consider processes or process flow that takes into account when the subset of candidate resources of the candidate resource set (S_{A}) is below the threshold.

In an aspect, the threshold used for ensuring that at least a subset of candidate resources (S_{A}′) being selected/reported is within the set of candidate resources (S_{A}) can be configured differently. For example, the threshold can be a ratio (Y) of reported candidate resources in the SL DRX active time of the receiver/receiving UE over all the reported candidate resources so that the subset of candidate resources being reported overlapping with the SL DRX active time is larger than or equal to the threshold (Y). In other words, a percentage threshold of the candidate resource set (S_{A}) includes at least the subset of candidate resources within the indicated SL DRX active time. Alternatively, or additionally, the threshold can be a number (Z) of reported candidate resources in SL DRX active time so that the number of the at least the subset of candidate resources overlapping with the SL DRX active time is larger than or equal to the threshold (Z). Alternatively, or additionally, the threshold can be a number (W) of candidate slots in the SL DRX active time to ensure that a threshold (W) number of candidate slots being selected is within the active time of the SL DRX active time, for example.

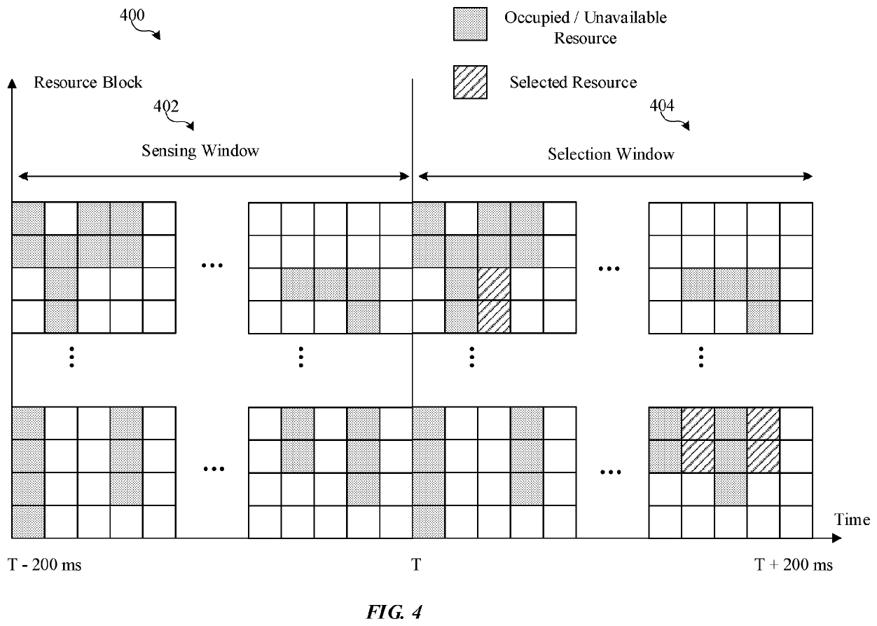

FIG. 4 illustrates an example timing of a sensing and selection process 400 in accord with various aspects. In the 5G NR mode-2 SL communication, the base station does not intervene in the resource selection process of the UE or terminal node, as such each UE selects the usable resources itself. Each UE performs the sensing procedure 402 by decoding the PSCCH to determine which resources are not occupied by other terminals. Thus, resource sensing 402 is performed prior to data transmission, or prior to the transmitting UE transmitting/reporting to the receiver UE, which can be from PHY layer to a higher layer (e.g., a MAC layer or beyond).

In the example timing of sensing and selection processes 400, the length of the sensing window 402 is set to 200 ms, but can be smaller or larger, for example. The timing of the sensing and selection process 400 corresponds to the method of full sensing, which can be applied mostly to V-UEs, for which considerably less severe restrictions on power consumption are imposed, but is not limited to P-UEs or the like. “T” denotes the timing corresponding to the start of the selection window. The sensing window 402 starts at time T−200 ms, that is, 200 ms before T.

During the sensing window 402 period, each terminal undergoes the sensing process of decoding the PSCCH resource blocks being used by all UEs of an area. Thus, resource sensing 402 can be used to identify the occupied resources (e.g., as indicated by shaded resources/resource blocks) and to exclude these occupied resource blocks from the candidate resource set (or set of candidate resources). Some resources may also not be available if the UE is not monitoring these. After the candidate resource set is obtained through the sensing process 402, the resource blocks to be used for data transmission are selected from the total candidate resources minus the excluded or unavailable resources during the selection window 404. Through this process, even if the base station does not allocate resource blocks, the UE can identify the resource blocks being used by all other terminals and thus prevent collision by selecting adequate resource candidates (e.g., as indicated in hash marked resource blocks) for SL communication. Here, at least a subset of candidate resources of the candidate resource set being reported can be configured to overlap with an indicated SL DRX active time of a receiver UE by various mechanisms, such as by enabling resource selection details for P2V (V2P) communication based on partial sensing approaches and alongside corresponding agreements in 3GPP.

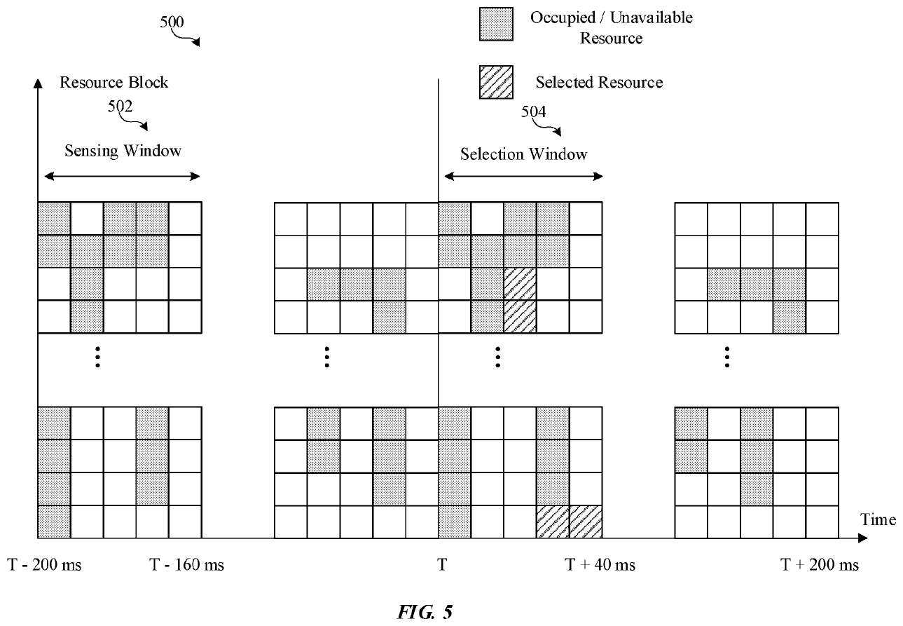

FIG. 5 illustrates an example timing of a partial sensing/reduced sensing and selection process 500 in accord with various aspects. The method of partial sensing and aspects related herein can be effective for P-UEs, or any device with power consumptions restrictions, and is not necessarily limited to P-UEs or other UE devices, but can also apply to any UE. Sensing is performed for only a partial sensing window 502 (e.g., 40 ms or other partial period) for an entire observation period of 200 ms. “T” denotes the timing where the resource selection window (RSW) 504 begins. Here, sensing at each UE is performed only for 40 ms, corresponding to the time interval from T−200 ms to T−160 ms. Because PSCCH decoding is performed only for 40 ms (T−200 ms to T−160 ms), the RSW 504 is reduced to 40 ms (from T to T+40 ms). Thus, usable resources are selected for the RSW 504 of 40 ms.

The main purpose of the partial sensing for the P-UE is to perform sensing with reduced power consumption. The power consumption of the UE can be directly linked to the duration of the sensing, therefore reducing the sensing duration (i.e. doing partial sensing), can be essential for power saving. However, if the sensing duration is extremely reduced, the system performance can degrade. Thus, partial sensing also allows the P-UE to avoid selecting some resources which are reserved by transmissions with 200 ms periodicity, and not necessarily always be able to detect any reserved resource(s) (e.g., control channel elements (CCEs) or CCE candidates, subframes, bandwidth, frequency, transmission opportunity, number of antenna ports, orthogonal frequency division symbols, or the like) with higher periodicity, which could share the same selection window as the P-UE.

Example agreements that could be standardized with 3GPP include that at least a subset of candidate resources of the set of candidate resources being selected/reported overlap with the SL DRX active time of the receiver UE by satisfying a threshold. The threshold can be configured or indicated to the transmitting UE either by being (pre)configured per resource pool or a resource pool configuration from an RRC signaling or a higher layer, for example. Alternatively, or additionally, the threshold being used could be negotiated between the transmitting UE (e.g., UE 110-1 of FIG. 1) and a receiving UE (e.g., 110-2 of FIG. 1). For example, because the receiving/receiver UE's DRX is being considered, the receiver UE 110-2 can indicate to the TX UE 110-1 that 30 percent of identified candidate resources should be within the SL DRX active time. Such a negotiation could be dependent on the UE's capability or the parameters of the SL DRX active time, for example.

As discussed above, the threshold can be configured as at least one of: a portion or ratio (Y) of reported candidate resources within an SL DRX active time of the receiver UE, a number of reported candidate resources (Z) within the SL DRX active time, or a number of candidate slots (W) overlapping with the SL DRX active time. The PHY layer of the transmitting UE 110-1 can report some candidate resources to the MAC layer, but within the reported candidate resource a certain portion or percentage of reported resources is within the RX UEs active time. For example, if the UE 110-1 reports 100 resources to the MAC layer, then the portion Y (e.g., 30% or otherwise) can be configured to be within the RX UEs active time. If the number of reported candidate resources (Z) is used, then, for example, if 100 resources are to be selected/reported, at least maybe 50 (or other number) of them is within the RX UEs active time as the threshold Z, and similarly if utilizing the number of candidate slots (W). The threshold (Y, Z, or W) can be used to ensure that the subset of candidate resources of the candidate resource set being selected at a PHY layer within the RSW 504 satisfies the threshold for overlapping resources within the SL DRX active. One way to utilize the threshold and ensure it is satisfied for SL communication is to modify the RSW 504 for the resource selection procedure based on one or more conditions.

In one example, the RSW 504 or a size of the RSW of the resource selection procedure can be modified to ensure that at least a subset of the candidate resources in the reported candidate resource set overlaps with the SL DRX active time. In an aspect, the RSW can be modified, for example, in terms of a ratio (Y′) of overlapping resource slots between the RSW and the receiver UE's active time over the RSW size. Thus, the RSW 504 can be configured to be larger or equal to the ratio (Y′). Y′ can be derived based on the ratio or percentage Y as discussed above so that the RSW ensures the threshold Y is satisfied, or Y′ could be indicated by a resource pool configuration from a higher layer, for example. Alternatively, or additionally, the RSW 504 can be modified based on a number of overlapping slots (Z′) as derived from threshold Z (the number of candidate resources within the SL DRX active time) or W (number of candidate slots within the SL DRX active time) in order to ensure that the RSW size satisfies one or more of these thresholds. Z′ could also be indicated by a higher layer configuration, for example.

For example, if the receiver UE's SL DRX active time is within slots 10 to 20 and an initial resource selection window/RSW 504 is from slot 0 to slot 50, the UE needs to modify the RSW 504 to be within the receiver UEs active time and satisfy the ratio (e.g., Y′=0.50). Thus, the candidate slots between the RSW 504 and the SL DRX active time should be equal or larger than 50%, and the UE 110-1 can restrict the RSW from 0 to 50 to 0 to 20 if slot 10 to 20 is within the RX UE's active time. So by restricting the RSW 504 by the initial candidate slot, at least half of the candidate slots can be within the RX UE's active time. Alternatively, or additionally, the transmit UE can ensure a number of overlapping slots between the RSW and the RX UE's active time is larger or equal to a number or percent threshold Z′ that can be derived from either ra number of reported candidate resources (Z) or a number of candidate slots (W) that are pre-configured or negotiated between the transmit UE 110-1 and the receiver UE 110-2, for example.

In an aspect, the remainder of the RSW can be configured to be after the selected RSW that overlaps with the SL DRX UE active time. In other words, the remainder of the RSW beyond the RSW that overlaps with the SL DRX UE inactive time can be configured or extended to be after the selected RSW satisfying the threshold. For example, if the RX UE's active time is configured to be from slot 11 to 20, then UE 110-1 can select slot 11 to 20 as the initial resource selection window RSW and extend the RSW after slot 20. Accordingly, the RSW can be modified such that it ranges from slot 11 to slot 30, for example.

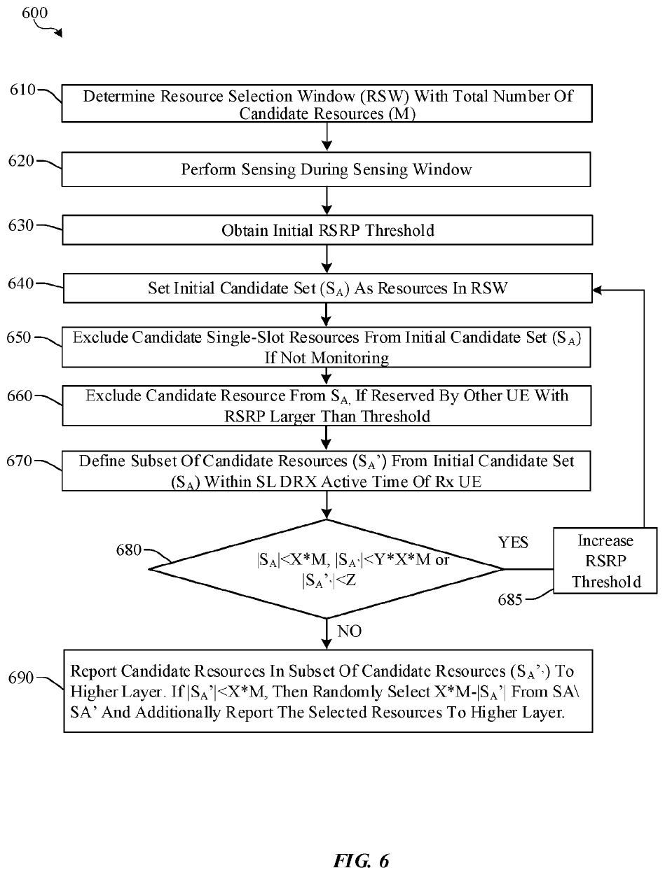

FIG. 6 illustrates an example process flow 600 for a resource (re) selection procedure that factors into account the SL DRX of the receiver UE for mode-2 SL communication in accord with various aspects. An SL DRX active time of the receiver UE (e.g., 110-2, or other UE) can be indicated from the MAC layer for candidate resource selection to be used for SL communications. In response to receiving the indicated SL DRX active time, the transmitting UE 110-1 can apply a restriction at the PHY layer so that at least a subset of candidate resources being reported to the MAC layer is located within the indicated active time of the RX UE. Various aspects for the resource selection procedure 600 can operate to restrict resources for candidate resource selection while taking into account the indicated active time from the MAC layer, for example. The PHY layer can then be configured to select and report candidate resources where at least a subset of the candidate resources is within the indicated active time of the RX UE based on one or more thresholds being satisfied.

The method initiates at 610 with determining an RSW (e.g., 504) based on a total number of sidelink candidate resources (M) within a period, a timed window, or a time of potential candidate resources. The PHY layer of the transmitting UE 110-1 determines the parameters of the RSW 504, and the total number of the candidate resources in this window, which can be denoted as M.

When determining the RSW 504, the RSW can be configured or modified based on the indicated SL DRX parameters (e.g., the SL DRX active time/inactive time, a required number/portion of reported resources, a threshold as a ratio (Y) or a number (Z) of candidate resources/slots for overlap in the SL DRX active time, etc.). The RSW, for example can be denoted as [n+T1, n+T2], where n can be a time of the resource selection slot, and T1 the beginning slot time offset and T2 the ending slot time offset of the RSW. From the threshold configured, the UE can derive either a ratio (Y′) of overlapping slots between the RSW and the SL DRX active over an RSW size, and set this ratio as a modification threshold for the RSW so that it satisfies the ratio, and the overlapping slots is larger than or equal to the ratio (Y′), for example. The ratio Y′, for example, can be derived from an indicated ratio or percentage of reported candidate resources to be within the SL DRX active time. Any remaining RSW can be configured to come after the selected RSW that overlaps the UE's SL DRX active time.

Alternatively, or additionally, this modification threshold or threshold used for modification/configuration of the RSW 504 can be derived as a number (Z′) of overlapping slots (Z′) between the RSW and the SL DRX active time for SL communication. The number Z′ can be configured for the RSW so that the number Z′ is satisfied, and the overlapping slots are larger than or equal to the number Z′. The number Z′ can be derived by the UE 110-1 from either a number (Z) of reported candidate resources indicated to be within the SL DRX active time or a number (W) of candidate slots indicated to be within the SL DRX active. Any remaining RSW can be configured to come after the selected RSW that overlaps the UE's SL DRX active time.

At 620, the method 600 continues with sensing during a sensing window (e.g., 502) for candidate resources to be used for the mode-2 SL communication. The sensing window is configured for sensing before the RSW (e.g., 504) to decode a PSCCH, and can be partial sensing window or full sensing window, for example.

At 630, an initial reference signal received power (RSRP) threshold can be obtained. The sensing window is used to monitor resources from other UEs as well as perform S-RSSI/RSRP measurements to select the most suitable resources within the selection window 504, for example, for use in SL communication.

At 640, an initial candidate resource set (S_{A}) is selected according to the RSRP threshold based on the RSW 504. Here, all the resources within the timed RSW 504 can be set as a candidate resource set/set of candidate resources, denoted as S_{A}, or referred to as the initial candidate set as all resources in the RSW 504.

At 650, the candidate single-slot resources can be excluded from the initial candidate resource set S_{A} if these slots are not being monitored by the UE 110-1.

At 660, if the UE 110-1 detects that some resources have been reserved by another UE by performing sensing operations, the UE 110-1 can exclude those reserved resources from the initial resource set S_{A}, especially by another UE with an RSRP threshold that is larger than the RSRP threshold used for the resource selection process flow. Transmissions that are received by the UE 110-1 can occupy resources, which are periodically allocated and can be projected onto some resources within the UE (re) selection window (n) (e.g., window 504). Thus, because the UE knows these resources are already occupied by its reception of these transmission, the P-UE or UE 110-1 can operate to exclude these resources from a resource candidate set (e.g., a dataset storage, or other storage) as reserved for retransmission by another UE device or network component, for example. The UE 110-1 can independently treat each partial sensing window allocated, for example, within a period of seconds, milliseconds (ms) or other complete sensing window. Thus, if multiple partial sensing windows are configured within a configured sensing window, the UE 110-1 can independently process each of them, detect all corresponding resource reservation periods and corresponding resources to be excluded from use in selecting resources and generating an SL transmission.

At 670, a subset of candidate resources S_{A′} that is part of the initial candidate resource set S_{A} can be defined as a subset of overlapping candidate resources within the indicated SL DRX active time of the receiver UE 110-2 based on one or more thresholds discussed herein. According to various conditions, an iterative procedure can be used to select the candidate resource set that satisfies the threshold (e.g., Y, W, or Z). That is, for example, one or more iterations of the resource selection procedure to ensure at least Y % (e.g., Y=20%, or other ratio) of total available resources for selection within UE resource (re) selection window or RSW of resource candidates that overlaps within the SL DRX active time of the receive UE 110-2. Other thresholds discussed, such as a number of candidate resources or a number of candidate slots overlapping the SL DRX active could also be utilized.

The conditions for iteration of another round of resource sensing/exclusion and modification of the initial candidate set to ensure satisfaction of the threshold can be defined in decision 680 for determining whether these conditions have been satisfied. The conditions can include whether the initial candidate resource set S_{A} is less than a reported portion (X) of the total (M) number of sidelink candidate resources (|S_{A}|<X*M). Alternatively, or additionally, another condition can include whether a number of subset candidate resources of the subset of candidate resources (Sa′) within the SL DRX active time of the receiver UE is less than a number threshold (|S_{A′}|<Z).) or a percentage threshold (Y) of the reported portion (X) of the total number of sidelink candidate resources (|S_{A′}|<Y*X*M). If any of these conditions are satisfied as “Yes”, then the process flows to 685 for increasing or modifying the RSRP threshold. If any of these conditions are not satisfied, then the process flows to 690 for reporting the data in SL communication from the PHY layer to a higher layer (e.g., a MAC layer). Alternatively, or additionally, these conditions could be represented as follows: |S_{A}|≥X*M and (|S_{A′}|≥Y*X*M or |S_{A′}|≥Z), as the converse of |S_{A}|<X*M, or |S_{A}|<X*M, or (|S_{A′}|<Y*X*M) (with the “Yes” and “No” designations being switched).

In response to one or more conditions being satisfied, another iteration of the resource selection procedure can be performed by modifying the RSRP threshold at 685, re-selecting the initial candidate resource set based on the RSW and excluding the unavailable candidate resources, and re-defining the at least the subset of candidate resources that is within the SL DRX active time.

Here, if the remaining resources in the initial candidate set or set of candidate resources S_{A} is less than a certain percentage or reported portion X times the total number of candidate resources M, another iteration of a loop in the resource selection procedure can be performed again because there are too few candidate slots for transmission, but otherwise the UE reports the resources to the higher layer from a PHY layer. At 684, a 3 dB adjustment, for example, or other adjustment amount of priority dependent reference signal received power (RSRP) thresholds can be reused to form or reselect the candidate resource set of the predefined size.

S_{A}′ is defined as the subset of candidate resource S_{A} that is within the indicated active time of the RX UE. Thus, the decision box 680 has the condition |S_{A}|<X*M and additionally |S_{A′}|<Y*X*M. If S_{A}′ as the number of resources in this set is less than Y (a percentage threshold) times X times M, then another iteration can be performed by increasing or modifying the RSRP threshold. As stated above, M is the total number of candidate resources and X is a required number or percentage of the reported resources, and Y is an additional percentage threshold imposed due to consideration of the SL DRX active time of the receiver UE 110-2, for example. If this S_{A}′ size is smaller than Y*X*M, then the resulting candidate resources are not enough that are within the RX UE's DRX active time so more candidate resource in this S_{A}′ set are needed to satisfy the threshold amount. If both of these conditions are not satisfied, then there are enough candidate resources within or overlapping in the RX UE's DRX active time and reporting at 690 can occur without additional iteration.

Then at 690, the set S_{A}′ can be reported to a higher layer. However, if this is still not large enough (if |S_{A}′|<X*M), then the UE 110-1 can additionally report the candidate resources in the S_{A} set but that are not in the subset S_{A′}. This is the remaining number or remainder of the resources in the RSW, denoted as: X*M−|S_{A}′|. Thus, the requirement for a percentage (X) of total (M) resources (X*M) to be reported can thus be satisfied while ensuring an adequate number of subset candidate resources of the set of candidate resources is within the SL DRX of the receiver UE 110-2, for example. In other words, at 690 first UE 1101-1 needs to report X*M as the total for the set of candidate resources being reported, first report the subset S_{A}′ is reported and if this still does not reach this X*M then other resources in S_{A} that is not in S_{A}′ can be randomly selected. Here, the percentage X can be configured by a high layer configuration or parameter “sl-TxPercentageList”; Y can be the indicated ratio threshold or percentage, which can also be replaced by a threshold number of reported candidate resources within the SL DRX active time as an indicated number threshold.

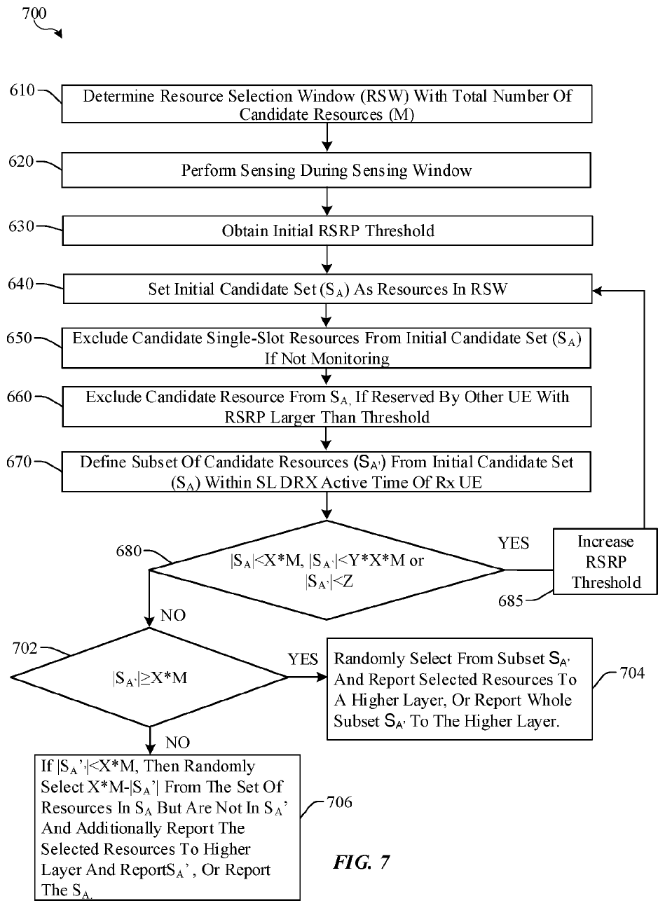

FIG. 7 illustrates another process flow 700 similar to FIG. 6 for a reselection procedure that takes into account the SL DRX of the receiver UE for mode-2 SL communication in accord with other various aspects. The process flow 700 is similar to the process flow 600 of FIG. 6, but with some additional aspects. Specifically, decision 702 can be made where decision 680 is determined as “NO” for determining whether |S_{A′}|≥X*M. Here, if the subset of candidate resources S_{A′} from the candidate resource set satisfies a required percentage of total reported resources (X*M) (as configured by higher layer (e.g., “sl-TxPercentageList”)), then the process flows to 704 where the UE can randomly select resources from S_{A′} to report, or report S_{A′} from the PHY layer to a higher layer for SL communication.

If the decision at 702 is “NO”, then the set S_{A}′ alone is still not large enough to satisfy the required percentage of total reported resources (X*M) (if |S_{A′}|<X*M), then the UE 110-1 can additionally report the candidate resources that are in the S_{A} set but that are not in the subset S_{A}′; or report the S_{A}. This is the remaining number or remainder of the resources in the RSW, denoted as: X*M−|S_{A}′|. As such, the requirement for a percentage (X) of total (M) resources (X*M) to be reported can thus be satisfied while also satisfying the threshold for an adequate number of subset candidate resources of the set of candidate resources is within the SL DRX of the receiver UE 110-2.

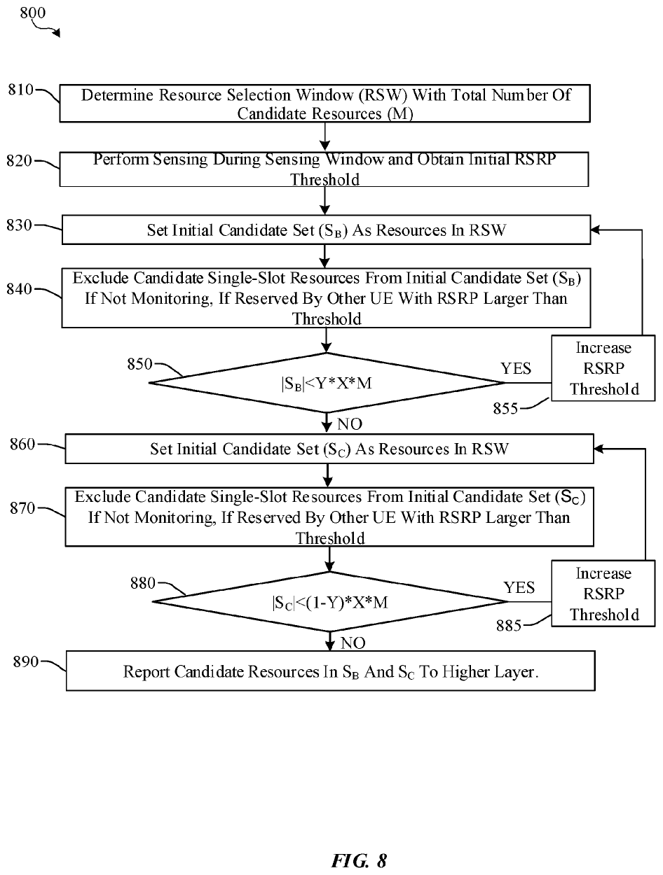

FIG. 8 illustrates another process flow 800 similar to FIGS. 6 and 7 for a resource selection procedure that takes into account the SL DRX of the receiver UE for mode-2 SL communication in accord with other various aspects. The process flow 800 comprises two rounds of resource selection processes in factoring in the SL DRX of the receiver UE, including both SL DRX active time and SL DRX inactive time.

Steps 810 thru 840 of process flow 800 are similar to steps 610 thru 660 of FIGS. 6 and 7. In particular, 810 can also be referenced as 610, and 820 could be referenced as a combination of 620 and 630, but designated 810 and 820 for simplicity of discussion. However, at 830 an initial candidate set S_{B} is restricted to only the resources within the intersection of the indicated SL DRX active time of the receiver UE 110-2, and the exclusion of resources at 650 and 660 as also performed at 840 is also from this initial candidate set S_{B}. Sensing and resource selection for this set can be all in this initial candidate set S_{B}.

At decision 850, a determination is made as to whether the candidate set S_{B} is less than the threshold Y times the require number or percentage being reported of the total number of candidate resources (|S_{B}|<Y*X*M); or alternatively, |S_{B}|<Z, where Z refers to a threshold number of candidate resources to overlap the SL DRX active time is. If the decision 850 is “Yes”, then the process flows to 855 where the RSRP threshold is increased, and another iteration of the process flow occurs for re-defining the initial candidate set S_{B}.

In response to the decision 850 being “NO”, a second phase of the process flow continues so that a candidate set S_{C} is defined starting at 860. Here, candidate set S_{C} is restricted as the resources in the RSW that are not in the SL DRX active time of the receiver UE, or within the inactive time of the SL DRX. Sensing and resource selection is thus entirely in candidate set S_{C}. At 870 any unavailable resources are then excluded, as discussed in relation to 840 above, but are excluded from the candidate set S_{C}.

At 880, a determination can be made as to whether candidate set S_{C} is less than the remainder of Y*X*M, or (1−Y)*X*M, or otherwise represented as (|S_{C}|<(1−Y)*X*M, or (|S_{C}|<X*M−Z) if the threshold number of resources Z is configured for resource selection.

At 890, both candidate set S_{B} and the candidate set S_{C} can be reported to a higher layer from a PHY layer, for example, either together or as separate steps.

While the methods described within this disclosure are illustrated in and described herein as a series of acts or events, it will be appreciated that the illustrated ordering of such acts or events are not to be interpreted in a limiting sense. For example, some acts can occur in different orders and/or concurrently with other acts or events apart from those illustrated and/or described herein. In addition, not all illustrated acts can be required to implement one or more aspects or embodiments of the description herein. Further, one or more of the acts depicted herein can be carried out in one or more separate acts and/or phases. Reference can be made to the figures described above for ease of description. However, the methods are not limited to any particular embodiment, aspect or example provided within this disclosure and can be applied to any of the systems/devices/components disclosed herein.

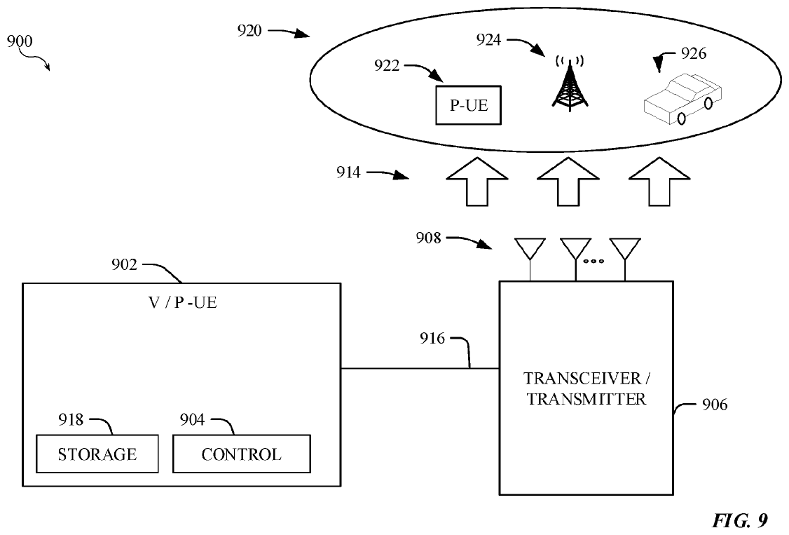

FIG. 9 is a diagram illustrating a system 900 for sidelink communications as direct communication via one or more vehicle UEs, pedestrian UEs, or other network devices. The system 900 facilitates sidelink communications by enhancing reliability and accuracy to data during power saving procedures such as resource selection procedures, partial or reduced sensing operations, re-evaluation/pre-emption checking for aperiodic transmissions in SL operation, and congestion control. The system 900 can be employable at a UE or other network device (e.g., P-UE/UE device 110) that facilitates mode-2 SL communication with another UE for resource selection based on partial sensing process(es) and UE behaviors including re-evaluation/pre-emption checking and congestion control process(es) according to various aspects described herein.

The system 900 includes a vehicle/pedestrian user equipment (V/P-UE) 902, a transceiver 906, and vehicle/traffic participant entities 920, which can represent a V-UE, P-UE or other UE that could participate in SL communication through direct communication to each other. Although not shown, other components such as a packet gateway (PGW), a secondary gateway (SGW), a mobility management entity (MME), a packet data network (PDN), UEs, eNB, gNB or any other component described herein can be included.

The V/P-UE 902, for example, includes the transceiver 906, a storage component 918, and control circuitry or controller 904. The storage component 918 includes a memory, storage element and the like and is configured to store information for the V/P-UE 902. The controller 904 is configured to perform various operations associated with the V/P-UE 902. The controller 904 can include logic, components, circuitry, one or more processors (baseband circuitry processors 204A-E of FIG. 2 or other processing circuitry). The transceiver 906 includes transmitter functionality and receiver functionality. The V/P-UE 902 also includes one or more antenna 908 for communications, which includes emergency services broadcast communications 914 with the vehicle/traffic participant entities 920.

The vehicle/traffic participant entities 920 include one or more pedestrians 922, infrastructure entities 924, vehicle entities 926 and the like. The communications between the V/P-UE 902 and the vehicle entities 920 includes Vehicle to Everything (V2X), which includes Vehicle to Vehicle (V2V), Vehicle to Infrastructure (V2I) and Vehicle to Pedestrian (V2P). The entities 920 can also include a road side unit (RSU), which is an entity that supports V2I and is implemented in an eNodeB or a stationary/non-stationary UE/IoT.

The sidelink communications between the V/P-UE 902 and the vehicle or pedestrian entities 920 can utilize co-operative awareness that includes information from other vehicles, sensors, and the like, to process and share the information to provide vehicle services such as collision warning, autonomous driving, and the like.

The V2V communications can be between V/P-UEs that may be served by an evolved universal terrestrial access network (E-UTRAN) or where at least one of communicating V/P-UE may be out of network coverage for mode-2 SL communication. The V2I communications include application layer information to RSUs. The RSU sends application layer information to a group of UEs. The V2I also includes vehicle to network (V2N) communication where one party of the communications is a V/P-UE or UE and the other party is a serving entity, where both support V2N applications. The V2P can be SL communications that are between distinct UEs, including V/P-UEs and pedestrian associated UEs, where one UE is for each. The V2P communications include V2P related application information. This can include emergency services information through V2X communications and uses include, but not limited to, forward collision warning, control loss warning, V2V emergency vehicle warning, V2V emergency stop use case, V2I emergency stop use, wrong way driving warning, pre-crash sensing warning, warning against pedestrian collision, and the like.

Additionally or alternatively, resource (re) selection procedure/operations can include a resource exclusion, an iterative formation of a candidate resource set, SL-RSSI averaging of remaining resources, resource ranking and a randomized selection of resources from candidate resource set with minimum received energy. This can then be followed up with/preceded by and then sequentially repeated together with a sensing window/procedure to monitor the spectrum/medium/channels of communication by the UE and neighboring channels or communication devices detected according to aspects described herein.

In some aspects, rather than performing partial sensing, the UE 902 could be configured for full sensing, for example. UE 902 can also represent the transmitting UE 110-1 reporting in mode-2 SL communication to a receiver UE 922, for example, as UE 110-2. The UE 902 can be configured to also perform partial sensing, in which at least a minimum number Yₘᵢₙ of candidate slots could be configured for partial sensing, either from RRC signaling or a higher layer, for example. When the UE 902 receives an indication of the SL DRX active time or related DRX parameter of from which to derive the SL DRX active time from the UE 922 or other network component for the UE 922, the UE 902 can be triggered to operate sensing based on this information when in SL communication with UE 922.

In aspect, if the receiver UE's SL DRX parameters are being considered, then this Yₘᵢₙ threshold could be relaxed. Because Yₘᵢₙ is the minimum candidate slots based on partial sensing and on the TX UE power saving, when considering Rx UE's DRX the UE 902 may not be able to ensure that all of the Yₘᵢₙ candidate slots based on partial sensing are in the Rx UE's DRX active time. As such, UE 902 can determine to not utilize the minimum number of slots required for partial sensing when being indicated the Rx UE's DRX. In particular, Yₘᵢₙ can be enabled or disabled by a resource pool (pre)configuration, for example, or signaled by a higher layer.

For example, a resource pool for example could indicate a smaller number Yₘᵢₙ′ that is smaller than Yₘᵢₙ when considering a receiver UE's DRX configuration. In this case, the UE 902 ensures that the Yₘᵢₙ′ number of candidates slots is satisfied rather than a pervious configuration of Yₘᵢₙ.

In an aspect, a different minimum number of candidate slots Yₘᵢₙ′ smaller than Yₘᵢₙ can be (pre)configured for use with partial sensing when the receiver UE 922 indicates SL DRX. Alternatively, or additionally, the number of candidate slots in the SL DRX active time of Rx UE can be configured to be larger than or equal to a (pre)configured threshold number of candidate slots (W), depending on whether W or Yₘᵢₙ is smaller so that Yₘᵢₙ′=Min (W, Yₘᵢₙ). Thus, the minimum between W and Yₘᵢₙ can be set as the minimum number of candidate slots to be utilized for partial sensing; if when considering the other threshold number of candidate slots W for the number of reported candidate resources in active time of Rx UE.

Alternatively, or additionally, if the number of reported candidate resources (Z) in active time of Rx UE is larger than or equal to a (pre)configured threshold (Z), then the UE 902 can consider that Z is the number of reported candidate resources in active time of Rx UE. Then the UE 902 can configure Z divided by the number of subchannels that is in the frequency domain and take the minimum between them as Y′ₘᵢₙ as represented by Y′ₘᵢₙ=Min (Z/N_{subchannel}, Yₘᵢₙ); where Yₘᵢₙ is set as the minimum number of candidate slots required for partial sensing, where N_{subchannel} is the number of sub channels in a resource pool.

In other aspects, when the UE 902 is being indicated the receiver UE's SL DRX, then the transmitter UE 902 can be configured to increase the partial sensing occasions such that Yₘᵢₙ threshold is still followed or adhered to. The UE 902 can then more sensing so it can satisfy the Yₘᵢₙ threshold, and define at least Yₘᵢₙ candidate resources. The UE 902 sensing occasion(s) can be increased so that a certain percentage/number of them overlaps within the receiver UE's SL DRX active time.

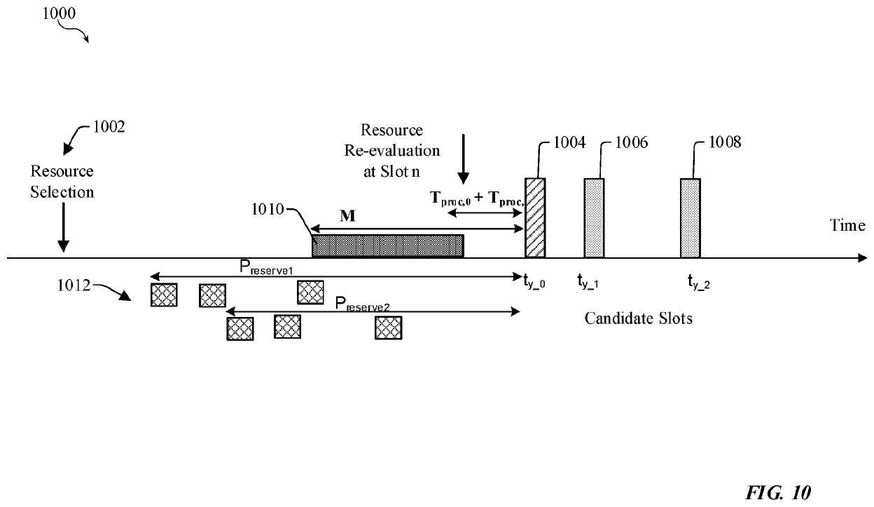

FIG. 10 illustrates an example of re-evaluation/pre-emption checking timing 1000 for aperiodic transmission in SL transmission in accord with the various aspects herein. Resource re-evaluation and pre-emption checking can be configured in NR sidelink to reduce the probability of resource collision and ensure that any selected resource is still available or adequate just before transmission. When configuring partial sensing as a power saving mechanism, periodic-based partial sensing (PBPS), contiguous partial sensing (CPS), or both schemes are configured for resource re-evaluation and pre-emption checking.

Resource re-evaluation and pre-emption checking can include resource selection 1002 for aperiodic traffic, which is one-shot traffic in the initial resource selection, for example. The one time aperiodic resource that is selected is represented at 1004, while 1006 and 1008 resources have not been selected for use, but are remaining resources. At the time n, just before the transmission at t_{y_0}, the UE 110-1 performs the resource re-evaluation or pre-emption checking where the selected resource 1004 is checked whether it is still available or not. In particular, the re-evaluation or pre-emption checking can be performed on the initial candidate resource set that is also to be the same as the set in the initial resource selection, which includes both the selected resource 1004 and the remaining resources 1006 and 1008. Thus, the candidate resource set or set of candidate resources (S_{A}) can include 1004 thru 1008 resource candidates.

The candidate resource set 1004 thru 1008, the sensing occasions for PBPS 1012, and CPS monitoring window 1010 are configured when a UE performs resource re-evaluation and pre-emption checking with partial sensing for periodic transmission, and the UE 110-1 can configure PBPS or CPS. The timing of when the transmitting UE 110-1 or 902 performs resource re-evaluation and pre-emption checking with partial sensing for aperiodic transmission can be configurable.

In an aspect, when performing a re-evaluation or a pre-emption check of one or more selected candidate resources of the set of candidate resources from the resource selection procedure for an aperiodic transmission, the UE 110-1 can perform a partial sensing so that the set of candidate resources starts from the one or more selected candidate resources and ends at a last slot of candidate slots based on slot indices utilized in the resource selection procedure 1002. In this manner, the candidate resource set (S_{A}) can be initialized according to remaining Y candidate slots and according to slot indices of the remaining Y candidate slots that were used in the initial resource selection procedure (e.g., process flows 600 thru 800).

For example, in the timing 1000, the UE 110-1 first selects a set of sidelink resources for its aperiodic transmission at 1002 along this timeline. The UE 110-1 then performs resource re-evaluation and pre-emption checking at slot n, in order to ensure the resources are still available or adequate for SL transmission, where n can equal the time from the selected resource (t_{y_0}) minus a period of time or slots (T₃) such that n=t_{y_0}−T₃, where t_{y0} is the slot of the selected resource 1004. The UE 110-1 can be configured to configure the candidate resource set for resource re-evaluation and pre-emption as initialized according to the remaining Y candidate slots (e.g., t_{y_1} and t_{y_2}) of candidates 1006 and 1008 used in the initial resource selection, which can start from slot t_{y_1} and end at the last slot t_{y_2} of the Y candidate slots.

To support the remaining Y candidate slots with sufficient sensing results, the UE 110-1 can perform contiguous partial sensing in a CPS sensing window 1010 starting from M logical slots earlier than t_{y_0} to T_{proc,0}+T_{proc,1} slots earlier than t_{y_0}, where T_{proc,0} is a processing time of the sensing results, and T_{proc,1} can be a preparation time for the physical sidelink shared channel (PSSCH) as an SL transmission of sidelink data. Thus, the UE 110-1 performs CPS sensing for aperiodic transmissions (e.g., a unicast communication or the like) as the partial sensing based on a sensing window 1010 that is at least M logical slots plus one or more logical slots as T_{proc,0}+T_{proc,1} before a selected resource 1004 of the one or more selected candidate resources 1004 thru 1008, where M can be up to 31 slots or another preconfigured number of slots, for example. The default value of M can be 31, for example, unless (pre-) configured with another value. Also, the CPS monitoring window 1010 is configured to not start earlier than the slot of performing resource selection 1002.

If the UE 110-1 additionally, or alternatively, performs PBPS for its resource re-evaluation and pre-emption checking, then the PBPS sensing occasions 1012 can be configured as t_{y′-k+P}_{ᵣₑₛₑᵣᵥₑ}, where t_{y′} is a slot belonging to the remaining Y candidate slots, and k and Pᵣₑₛₑᵣᵥₑ can be the same parameters as used in the resource selection procedure at 1002. In other words, if the UE preforms PBS in the initial resource selection procedure as at 1002 within the RSW, then the parameters by which k and Pᵣₑₛₑᵣᵥₑ are also used for the re-evaluation/pre-emption checking to ensure resources are still reserved and adequate just before SL transmission.

Preserve1 indicates a periodicity that the UE 110-1 monitors. For example, Preserve1 can be 100 ms. To detect periodic resource reservation, the UE 110-1 monitors the SL channel at slots t_{y0-100}, t_{y1-100}, t_{y2-100} to ensure no other UEs reserve the resources at slot t_{y0}, t_{y1}, t_{y2} via periodic resource reservation by periodicity of 100 ms. Preserve2 can be another periodicity that the UE 110-1 also monitors. In one example, the UE 110-1 can monitor up to 16 periodicities (e.g., up to Preserve16) for the resource re-evaluation and pre-emption checking. K can be 1 or {1, 2}, or other range, for example, indicating for each periodicity, the number of monitoring occasions to monitor. For example, K={1,2} and for Preserve1-30, UE then monitors the SL channel at slots t_{y0-30}, t_{y1-30}, t_{y2-30}, t_{y0-60}, t_{y1-60}, t_{y2-60} to ensure no other UEs reserve the resources at slot t_{y0}, t_{y1}, t_{y2}.

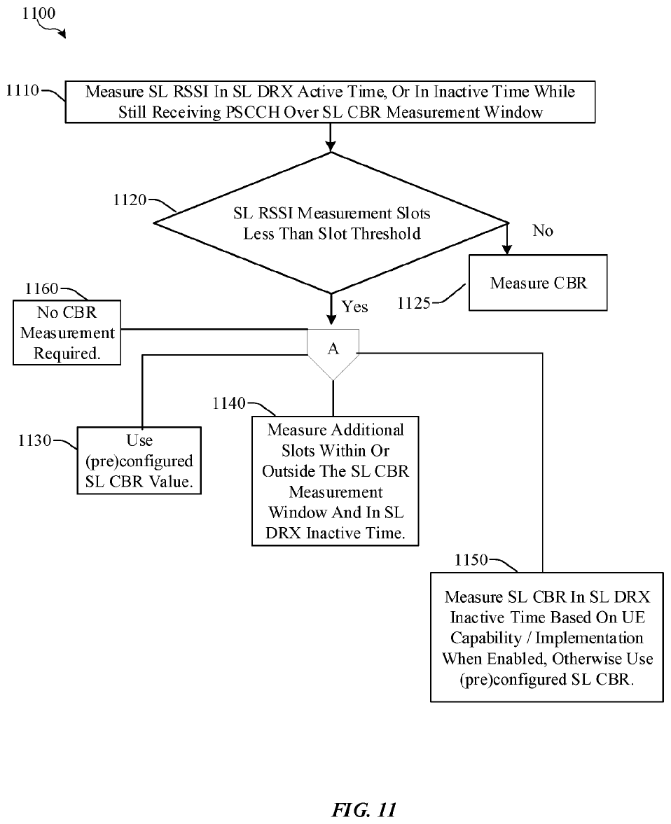

FIG. 11 illustrates an example process flow 1100 channel busy ratio (CBR) measurements that can be performed during an SL DRX inactive time based on one or more conditions in accord with other various aspects. Resource selection procedures with partial sensing for aperiodic transmission along with congestion control mechanisms can operate together according to various embodiments, aspects, or examples herein to enhance power saving in the UE for SL communication (e.g., mode-2 SL communication).

The UE 110-1, 110-2, 902, 922, or other UE as V-UE or P-UE, for example, can be configured with SL DRX as a part of power saving mechanisms, in which during the SL DRX inactive time the UE is not expected to receive any data; hence does not measure the channel (e.g., the PSCCH). A CBR measurement is used by the UE to determine whether to continue SL communication or not. If satisfying a CBR threshold, for example, the UE can cease or halt SL communication where the SL channel is too busy or inefficient to use for SL communication. In particular, the SL CBR is based on the SL RSSI measurement. A number of SL RSSI measurements within a CBR measurement window can be used to determine a CBR measurement, such as by SL RSSI averaging, for example, or by other means.

In an aspect, at 1110, the SL RSSI measurement can be performed first in the UE's SL DRX active time. Alternatively, or additionally, the SL RSSI measurement can be performed in the UE's inactive time in response to or when the UE is still receiving the PSCCH over the SL CBR measurement window. If the UE 110-1 is still receiving PSCCH in the SL CBR measurement window, the UE 110-1 can be configured or enabled to be able to perform the RSSI measurement in those slots even though the UE is in DRX inactive time.

The calculation of the SL CBR is limited to those slots in which the RSSI is measured. At 1120, a determination can be made whether the number of SL RSSI measurement slots is below a (pre)configured slot threshold. If the determination is “Yes” and the SL RSSI slots are less than a slot threshold, the RSSI measurements are not necessarily sufficient to support a CBR measurement due to the SL DRX inactive time, and the process flow continues to one or more alternatives at “A”. If “No”, then a CBR measurement can be obtained at 1125 to determine whether to halt SL communication or not based on a CBR threshold.

Alternatively, or additionally, at 1130, a (pre)configured SL CBR value can be used for a determination of the channel conditions and whether to cease SL communication based thereon. The (pre)configured SL CBR value may be the same or different from the (pre)configured SL CBR value for the partial sensing case. If there is no (pre)configured SL CBR value, or the measurement of additional slots is enabled, then the process flow can alternatively flow to 1140.

Alternatively, or additionally, at 1140, the UE can measure additional slots within or outside the SL CBR measurement window and within the UE's SL DRX inactive time depending on whether this operation is enabled/disabled by a resource pool (pre)configuration, for example. If the resource pool is (pre)configured to measure a set of slots within or outside the SL CBR measurement window, then the UE performs such measurement(s), otherwise the UE can follow a preconfigured CBR value as at 1130.

Alternatively, or additionally, at 1150, if a resource pool (pre)configuration enables measuring SL CBR within the SL DRX inactive time, the UE 110-1 can measure the SL CBR in its SL DRX inactive time based on the UE's capability or UE's implementation. If a resource pool has not (pre)configured or enabled measuring SL CBR within UE's SL DRX inactive time, then a (pre)configured SL CBR value can be used.

Alternatively, or additionally, at 1160 the UE could be configured to not measure CBR when the number of SL RSSI measurement slots is below a threshold or slot threshold, for example. In this case, when no SL CBR measurement result is available, a (pre)configured SL CBR value is used.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some embodiments, the circuitry can be implemented in, or functions associated with the circuitry can be implemented by, one or more software or firmware modules. In some embodiments, circuitry can include logic, at least partially operable in hardware.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

Examples (embodiments) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to embodiments and examples described herein.

A first example can be an user equipment (UE), comprising: a memory; and a processing circuitry configured to, when executing instructions stored in the memory, cause the UE to: receive an indication of a sidelink (SL) discontinuous reception (DRX) parameter of a receiver UE for a SL communication; perform a resource selection procedure based on the SL DRX parameter of the receiver UE to determine a set of candidate resources, wherein the set of candidate resources includes at least a subset of candidate resources satisfying a threshold of the SL DRX parameter of the receiver UE; and select one or more resources from the set of candidate resources to enable the SL communication.

A second example can include the first example, wherein the processing circuitry is further configured to: select the at least the subset of candidate resources at a physical (PHY) layer within a resource selection window (RSW) to satisfy the threshold based on the indication of the SL DRX parameter and report to MAC layer, wherein the threshold comprises at least one of: a portion of reported candidate resources within an SL DRX active time of the receiver UE, a number of reported candidate resources within the SL DRX active time, or a number of candidate slots overlapping with the SL DRX active time.

A third example can include the first or second example, wherein the processing circuitry is further configured to: determine the threshold based on a preconfigured ratio or a preconfigured number of candidate resources associated with a resource pool; or determine the threshold based on communication with the receiver UE, wherein the threshold comprises a portion of candidate resources, a number of candidate resources, or a number of candidate slots that overlap with an SL DRX active time of the receiver UE; wherein the at least the subset of candidate resources is equal to or greater than the threshold.

A fourth example can include any one or more of the first through third examples, wherein the processing circuitry is further configured to: determine an RSW based on a total number of sidelink candidate resources (M) within a timed window; perform sensing of candidate resources to be used for the SL communication during a sensing window before the RSW to decode a physical sidelink control channel (PSCCH); select an initial candidate resource set according to a reference signal received power (RSRP) threshold based on the RSW and excluding unavailable candidate resources; and define the at least the subset of candidate resources within the initial candidate resource set that is within an SL DRX active time of the receiver UE based on the threshold.

A fifth example can include any one or more of the first through fourth examples, wherein the processing circuitry is further configured to: modify a size of the RSW to ensure that a threshold portion of candidate slots, or a threshold number of candidate slots, overlap with the RSW and the SL DRX active time; and set a remainder portion of candidate slots or a remainder number of slots in the RSW to be after the threshold portion or the threshold number of candidate slots.

A sixth example can include any one or more of the first through fifth examples, wherein the processing circuitry is further configured to: in response to one or more conditions being satisfied, the one or more conditions including at least one of: the initial candidate resource set being less than a reported portion of the total number of sidelink candidate resources, or a number of subset candidate resources of the at least the subset of candidate resources within the SL DRX active time of the receiver UE being less than a number threshold or a percentage threshold of the reported portion of the total number of sidelink candidate resources: perform an iteration of the resource selection procedure by modifying the RSRP threshold, re-selecting the initial candidate resource set based on the RSW and excluding the unavailable candidate resources, and re-defining the at least the subset of candidate resources that is within the SL DRX active time.

A seventh example can include any one or more of the first through sixth examples, wherein the processing circuitry is further configured to: in response to the initial candidate resource set being equal to or greater than a reported portion of the total number of sidelink candidate resources, and a number of subset candidate resources of the at least the subset of candidate resources within the SL DRX active time of the receiver UE being equal to or greater than the number threshold or the percentage threshold of the reported portion of the total number of sidelink candidate resources, and in response to the at least the subset of candidate resources being no less than the reported portion of the total number of sidelink candidate resources: report the at least the subset of candidate resources to the higher layer by randomly selecting the reported portion of the total number of sidelink candidate resources or reporting each candidate resource of the at least the subset of candidate resources.

An eighth example can include any one or more of the first through seventh examples, wherein the processing circuitry is further configured to: in response to the at least the subset of candidate resources being less than the reported portion of the total number of sidelink candidate resources, randomly select at least one candidate resource in the set of candidate resources that is not in the at least the subset of candidate resources and report both the at least one candidate resource that is randomly selected and each candidate resource of the subset of candidate resources, or report the at least one candidate resource to the higher layer.

A ninth example can include any one or more of the first through eighth examples, wherein the processing circuitry is further configured to: perform the resource selection procedure based on an SL DRX active time of the receiver UE by: performing sensing of candidate resources to be used for the SL communication during a sensing window while obtaining an initial RSRP threshold associated with the SL DRX active time; restricting an initial candidate resource set to be selected within the SL DRX active time of the receiver UE, while excluding unavailable candidate resources; and in response to the initial candidate resource set being less than a number threshold or a percentage threshold of the reported portion of the total number of sidelink candidate resources, perform another iteration of the resource selection procedure with a modified RSRP threshold to re-define the initial candidate resource set that is within the SL DRX active time, otherwise report the initial candidate resource set.

A tenth example can include any one or more of the first through ninth examples, wherein the processing circuitry is further configured to: perform the resource selection procedure based on an SL DRX inactive time of the receiver UE by: performing sensing of candidate resources to be used for the SL communication during the sensing window while obtaining an RSRP threshold associated with the SL DRX inactive time; restricting another candidate resource set to be within the SL DRX inactive time; in response to the another candidate resource set being less than a remainder of the number threshold or a percentage threshold of the reported portion of a total number of sidelink candidate resources, perform another iteration of the resource selection procedure with another modified RSRP threshold to re-define the another candidate resource set that is within the SL DRX inactive time, otherwise report the another candidate resource set.

An eleventh example can include any one or more of the first through tenth examples, wherein the processing circuitry is further configured to: perform the resource selection procedure, including sensing of candidate resources based on a partial sensing window and an indication of whether a minimum number of candidate slots or a smaller minimum number than the minimum number of candidate slots for partial sensing is enabled or disabled by a resource pool configuration.

A twelfth example can include any one or more of the first through eleventh examples, wherein in response to a number of candidate slots being within an SL DRX active time of the receiver UE satisfying a threshold number of candidate slots, the smaller minimum number is enabled as a minimum of a threshold number of candidate slots or the minimum number of candidate slots, and in response to a number of candidate resources being within the SL DRX active time of the receiver UE, the smaller minimum number is enable as the minimum of a threshold number of candidate resources over a number of sub channels in a resource pool or the minimum number of candidate slots.

A thirteenth example can include any one or more of the first through twelfth examples, wherein the processing circuitry is further configured to: increase a partial sensing occasion or a number of partial sensing occasions to satisfy the minimum number of candidate slots (Ymin) with a threshold number of the number of partial sensing occasions being within an SL DRX active time of the receiver UE.

A fourteenth example can include any one or more of the first through thirteenth examples, wherein the processing circuitry is further configured to: performing a re-evaluation or a pre-emption check of one or more selected candidate resources of the set of candidate resources from the resource selection procedure for an aperiodic transmission by performing a partial sensing, wherein the set of candidate resources starts from the one or more selected candidate resources and ends at a last slot of candidate slots based on slot indices utilized in the resource selection procedure.

A fifteenth example can include any one or more of the first through fourteenth examples, wherein the processing circuitry is further configured to: perform contiguous partial sensing (CPS) as the partial sensing based on a sensing window that is at least M logical slots plus one or more logical slots before a first selected resource of the one or more selected candidate resources, wherein M is up to 31 slots or another preconfigured number of slots; or perform a periodic based partial sensing (PBPS) based on a periodicity utilized for the resource selection procedure; wherein the CPS and the PBPS initiate after a resource selection of the set of candidate resources.

A sixteenth example can include any one or more of the first through fifteenth examples, wherein the processing circuitry is further configured to: cease SL communication in response to an SL channel busy ratio (CBR) measurement based on an SL received signal strength indication (RSSI) being above a CBR threshold; measure the SL RSSI during an SL DRX active time or during an SL DRX inactive time when receiving a PSCCH within an SL CBR measurement window.

A seventeenth example can include any one or more of the first through sixteenth examples, wherein the processing circuitry is further configured to: in response to a number of SL RSSI measurement slots being below an SL RSSI measurement slot threshold due to the SL DRX inactive time, perform one or more of: using a preconfigured SL CBR value that is from a partial sensing operation for determining whether to cease the SL communication; or measuring an additional set of slots within or outside the SL CBR measurement window during the SL DRX inactive time based on being enabled or disabled by a resource pool configuration and a UE capability.

An eighteenth example can be a baseband processor comprising: a memory, and a processing circuitry configured to: receive an indication of a discontinuous reception (DRX) active time of a receiver user equipment (UE) for a sidelink (SL) communication; perform a resource selection procedure within a resource selection window (RSW) based on the SL DRX active time of the receiver UE to determine a set of candidate resources, wherein at least a subset of candidate resources of the set of candidate resources satisfies a threshold to be within the SL DRX active time of the receiver UE; and select one or more resources from the set of candidate resources to enable the SL communication.

A nineteenth example can include the eighteenth example, wherein the SL communication comprises an autonomous determination of SL resources as a Mode-2 sidelink communication.

A twentieth example includes any one or more of the eighteenth through nineteenth examples, wherein the processing circuitry is further configured to: modify the RSW of the resource selection procedure based on a percentage of candidate slots in the RSW overlapping the SL DRX active time satisfying a percentage threshold, or based on a number of candidate slots in the RSW overlapping the SL DRX active time satisfying a number threshold; and configure a remainder of time slots in the RSW to be after the RSW that overlaps the SL DRX active time.

A twenty-first example includes any one or more of the eighteenth through twentieth examples, wherein the processing circuitry is further configured to: in response to the at least the subset of candidate resources within the SL DRX active time being less than the threshold, or in response to the set of candidate resources being less than a percentage of a total number of candidate resources, increase a reference signal received power (RSRP) threshold to perform another iteration of the resource selection procedure within the RSW; and in response to the at least the subset of candidate resources within the SL DRX active time satisfying the threshold or the set of candidate resources satisfying the percentage of the total number of candidate resources, report the at least the subset of candidate resources to a higher layer; wherein the percentage of the total number of candidate resources is configured via a higher layer parameter.

A twenty-second example includes any one or more of the eighteenth through twenty-first examples, wherein the processing circuitry is further configured to: in response to the at least the subset of candidate resources within the SL DRX active time being less than the percentage of the total number of candidate resources, randomly select candidate resources from the set of candidate resources not within the at least the subset of candidate resources; and report the at least the subset of candidate resources within the SL DRX active time and the candidate resources randomly selected, or only report the set of candidate resources to a higher layer.

A twenty-third example includes any one or more of the eighteenth through twenty-second examples, wherein the resource selection procedure comprises different sets of processes for selecting resources within the at least the subset of candidate resources that overlap the SL DRX active time and other resources of the set of candidate resources that are within an SL DRX inactive time of the receiver UE, wherein a first set of processes comprises modifying an first RSRP threshold to perform another iteration of selecting resources within the SL DRX active time when the at least the set of candidate resources within the SL DRX active time is below the threshold, and a second set of processes comprises modifying a second RSRP threshold to perform a further iteration of selecting resources within the SL DRX inactive time when the other resources within the SL DRX inactive time is below an inactive threshold.

A twenty-fourth example can be a method for resource selection for sidelink (SL) communication: receiving, by a user equipment (UE), an indication of an SL discontinuous reception (DRX) parameter of a receiver UE; performing, by the UE, a resource selection procedure based on the SL DRX parameter of the receiver UE to determine a set of candidate resources, where the set of candidate resources includes at least a subset of candidate resources satisfying a threshold of the SL DRX parameter of the receiver UE; and select one or more resources from the set of candidate resources to enable the SL communication.

A twenty-fifth example can include the twenty-fourth example, further comprising: selecting the at least the subset of candidate resources within a resource selection window (RSW) to satisfy the threshold based on the indication of the SL DRX parameter comprising an SL DRX active time of the receiver UE, wherein the threshold comprises at least one of: a portion of reported candidate resources within the SL DRX active time, a number of reported candidate resources within the SL DRX active time, or a number of candidate slots overlapping with the SL DRX active time, and wherein the SL communication comprises an autonomous determination of SL resources as a Mode-2 sidelink communication.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the processes and/or actions of a method or algorithm can reside as one or any combination or set of codes and/or instructions on a machine-readable medium and/or computer readable medium, which can be incorporated into a computer program product.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

1. A user equipment (UE), comprising:
a memory; and
a processing circuitry configured to, when executing instructions stored in the memory, cause the UE to:
receive an indication of a sidelink (SL) discontinuous reception (DRX) parameter of a receiver UE for a SL communication;
perform a resource selection procedure to determine a set of candidate resources, wherein the set of candidate resources includes at least a subset of candidate resources satisfying a threshold of the SL DRX parameter of the receiver UE; and
use one or more resources from the set of candidate resources to enable the SL communication.

2. The UE of claim 1, wherein the processing circuitry is further configured to:
select the at least the subset of candidate resources at a physical (PHY) layer within a resource selection window (RSW) to satisfy the threshold based on the indication of the SL DRX parameter, wherein the threshold comprises at least one of: a portion of reported candidate resources within an SL DRX active time of the receiver UE, a number of reported candidate resources within the SL DRX active time, or a number of candidate slots overlapping with the SL DRX active time.

3. The UE of claim 1, wherein the processing circuitry is further configured to:
determine the threshold based on a preconfigured ratio or a preconfigured number of candidate resources associated with a resource pool; or
determine the threshold based on communication with the receiver UE, wherein the threshold comprises a portion of candidate resources, a number of candidate resources, or a number of candidate slots that overlap with an SL DRX active time of the receiver UE,
wherein the at least the subset of candidate resources is equal to or greater than the threshold.

4. The UE of claim 1, wherein the processing circuitry is further configured to:
determine an RSW based on a total number of sidelink candidate resources (M) within a timed window;
perform sensing of candidate resources to be used for the SL communication during a sensing window before the RSW to decode a physical sidelink control channel (PSCCH);
select an initial candidate resource set according to a reference signal received power (RSRP) threshold based on the RSW and excluding unavailable candidate resources; and
define the at least the subset of candidate resources within the initial candidate resource set that is within an SL DRX active time of the receiver UE based on the threshold.

5. The UE of claim 4, wherein the processing circuitry is further configured to:
modify a size of the RSW to ensure that a threshold portion of candidate slots, or a threshold number of candidate slots, overlap with the RSW and the SL DRX active time; and
set a remainder portion of candidate slots or a remainder number of slots in the RSW to be after the threshold portion or the threshold number of candidate slots.

6. The UE of claim 4, wherein the processing circuitry is further configured to:
in response to one or more conditions being satisfied, the one or more conditions including at least one of: the initial candidate resource set being less than a reported portion of the total number of sidelink candidate resources, or a number of subset candidate resources of the at least the subset of candidate resources within the SL DRX active time of the receiver UE being less than a number threshold or a percentage threshold of the reported portion of the total number of sidelink candidate resources:
perform an iteration of the resource selection procedure by modifying the RSRP threshold, re-selecting the initial candidate resource set based on the RSW and excluding the unavailable candidate resources, and re-defining the at least the subset of candidate resources that is within the SL DRX active time.

7. The UE of claim 6, wherein the processing circuitry is further configured to:
in response to the initial candidate resource set being equal to or greater than a reported portion of the total number of sidelink candidate resources, and a number of subset candidate resources of the at least the subset of candidate resources within the SL DRX active time of the receiver UE being equal to or greater than the number threshold or the percentage threshold of the reported portion of the total number of sidelink candidate resources, and in response to the at least the subset of candidate resources being no less than the reported portion of the total number of sidelink candidate resources:
in response to the at least the subset of candidate resources being no less than the reported portion of the total number of sidelink candidate resources, report the at least the subset of candidate resources to a higher layer by randomly selecting the reported portion of the total number of sidelink candidate resources or reporting each candidate resource of the at least the subset of candidate resources; and
in response to the at least the subset of candidate resources being less than the reported portion of the total number of sidelink candidate resources, randomly select at least one candidate resource in the set of candidate resources that is not in the at least the subset of candidate resources and report both the at least one candidate resource that is randomly selected and each candidate resource of the subset of candidate resources, or report the at least one candidate resource to the higher layer.

8. (canceled)

9. The UE of claim 1, wherein the processing circuitry is further configured to:
perform the resource selection procedure based on an SL DRX active time of the receiver UE by:
performing sensing of candidate resources to be used for the SL communication during a sensing window while obtaining an initial RSRP threshold associated with the SL DRX active time;
restricting an initial candidate resource set to be selected within the SL DRX active time of the receiver UE, while excluding unavailable candidate resources; and
in response to the initial candidate resource set being less than a number threshold or a percentage threshold of the reported portion of the total number of sidelink candidate resources, perform another iteration of the resource selection procedure with a modified RSRP threshold to re-define the initial candidate resource set that is within the SL DRX active time, otherwise report the initial candidate resource set; and
perform the resource selection procedure based on an SL DRX inactive time of the receiver UE by:
performing sensing of candidate resources to be used for the SL communication during the sensing window while obtaining an RSRP threshold associated with the SL DRX inactive time;
restricting another candidate resource set to be within the SL DRX inactive time; and
in response to the another candidate resource set being less than a remainder of the number threshold or a percentage threshold of the reported portion of a total number of sidelink candidate resources, perform another iteration of the resource selection procedure with another modified RSRP threshold to re-define the another candidate resource set that is within the SL DRX inactive time, otherwise report initial candidate resource set and the another candidate resource set.

10. (canceled)

11. The UE of claim 1, wherein the processing circuitry is further configured to:
perform the resource selection procedure, including sensing of candidate resources based on a partial sensing window and an indication of whether a minimum number of candidate slots or a smaller minimum number than the minimum number of candidate slots for partial sensing is enabled or disabled by a resource pool configuration.

12. The UE of claim 11, wherein in response to a number of candidate slots being within an SL DRX active time of the receiver UE satisfying a threshold number of candidate slots, the smaller minimum number is enabled as a minimum of a threshold number of candidate slots or the minimum number of candidate slots, and in response to a number of candidate resources being within the SL DRX active time of the receiver UE, the smaller minimum number is enable as the minimum of a threshold number of candidate resources over a number of sub channels in a resource pool or the minimum number of candidate slots.

13. The UE of claim 11, wherein the processing circuitry is further configured to:
increase a partial sensing occasion or a number of partial sensing occasions to satisfy the minimum number of candidate slots (Ymin) with a threshold number of the number of partial sensing occasions being within an SL DRX active time of the receiver UE.

14. The UE of claim 1, wherein the processing circuitry is further configured to:
performing a re-evaluation or a pre-emption check of one or more selected candidate resources of the set of candidate resources from the resource selection procedure for an aperiodic transmission by performing a partial sensing, wherein the set of candidate resources starts from the one or more selected candidate resources and ends at a last slot of candidate slots based on slot indices utilized in the resource selection procedure.

15. The UE of claim 14, wherein the processing circuitry is further configured to:
perform contiguous partial sensing (CPS) as the partial sensing based on a sensing window that is at least M logical slots plus one or more logical slots before a first selected resource of the one or more selected candidate resources, wherein M is up to 31 slots or another preconfigured number of slots; or
perform a periodic based partial sensing (PBPS) based on a periodicity utilized for the resource selection procedure,
wherein the CPS and the PBPS initiate after a resource selection of the set of candidate resources.

16. The UE of claim 1, wherein the processing circuitry is further configured to:
cease SL communication in response to an SL channel busy ratio (CBR) measurement being above a CBR threshold;
wherein the CBR measurement is based on an SL received signal strength indication (RSSI) measured within an SL CBR measurement window; and
in response to a number of SL RSSI measurement slots being below an SL RSSI measurement slot threshold, use a preconfigured SL CBR value for determining whether to cease the SL communication.

17. (canceled)

18. A baseband processor comprising:
a memory, and
a processing circuitry configured to:
receive an indication of a discontinuous reception (DRX) active time of a receiver user equipment (UE) for a sidelink (SL) communication;
perform a resource selection procedure within a resource selection window (RSW) based on the SL DRX active time of the receiver UE to determine a set of candidate resources, wherein at least a subset of candidate resources of the set of candidate resources satisfies a threshold to be within the SL DRX active time of the receiver UE; and
select one or more resources from the set of candidate resources to enable the SL communication.

19. The baseband processor of claim 18, wherein the SL communication comprises an autonomous determination of SL resources as a Mode-2 sidelink communication.

20. The baseband processor of claim 18, wherein the processing circuitry is further configured to:
modify the RSW of the resource selection procedure based on a percentage of candidate slots in the RSW overlapping the SL DRX active time satisfying a percentage threshold, or based on a number of candidate slots in the RSW overlapping the SL DRX active time satisfying a number threshold; and
configure a remainder of time slots in the RSW to be after the RSW that overlaps the SL DRX active time.

21. The baseband processor of claim 18, wherein the processing circuitry is further configured to:
in response to the at least the subset of candidate resources within the SL DRX active time being less than the threshold, or in response to the set of candidate resources being less than a percentage of a total number of candidate resources, increase a reference signal received power (RSRP) threshold to perform another iteration of the resource selection procedure within the RSW; and
in response to the at least the subset of candidate resources within the SL DRX active time satisfying the threshold or the set of candidate resources satisfying the percentage of the total number of candidate resources, report the at least the subset of candidate resources to a higher layer,
wherein the percentage of the total number of candidate resources is configured via a higher layer configuration or parameter.

22. The baseband processor of claim 21, wherein the processing circuitry is further configured to:
in response to the at least the subset of candidate resources within the SL DRX active time being less than the percentage of the total number of candidate resources, randomly select candidate resources from the set of candidate resources not within the at least the subset of candidate resources; and
report the at least the subset of candidate resources within the SL DRX active time and the candidate resources randomly selected, or only report the set of candidate resources to the higher layer.

23. (canceled)

24. A method for resource selection for sidelink (SL) communication:
receiving, by a user equipment (UE), an indication of an SL discontinuous reception (DRX) parameter of a receiver UE;
performing, by the UE, a resource selection procedure to determine a set of candidate resources, where the set of candidate resources includes at least a subset of candidate resources satisfying a threshold of the SL DRX parameter of the receiver UE; and
use one or more resources from the set of candidate resources to enable the SL communication.

25. (canceled)
